(19) United States
(12) Patent Application Publication
(10) Pub. No.: US 2008/0214206 A1
(43) Pub. Date: Sep. 4, 2008

(54) COMMUNICATION TERMINAL, COMMUNICATION SYSTEM USING SAME, AND INFORMATION DISPLAYING PROGRAM PRODUCT AND INFORMATION DISPLAYING METHOD FOR COMMUNICATION TERMINAL

(76) Inventors: Masahiro Shimanuki, Tokyo (JP); Masahiko Yahagi, Tokyo (JP); Naoyuki Amano, Tokyo (JP)

Correspondence Address: NEC CORPORATION OF AMERICA, 6535 N. STATE HWY 161, IRVING, TX, 75039, US

(21) Appl. No.: 12/035,138

(22) Filed: Feb. 21, 2008

(30) Foreign Application Priority Data
Feb. 21, 2007 (JP) 2007-041035

(51) Int. Cl. H04Q 7/20

(52) U.S. Cl. 455/456.1

(57) ABSTRACT

A communication terminal and communication system which are capable of having a grasp of a distance between communication terminals when communication is carried out, an information displaying program product and an information displaying method for the communication terminal and the communication system are provided. A communication network includes an originator terminal and receiver terminal connected to the communication network and a location information server to notify these terminals of the distance between these terminals or location information of each of these terminals. Each of the originator terminal and the receiver terminal, when location of each of these terminal is notified, calculates the distance between these terminals and displays the distance by a method of appealing to the five senses of a human to select a type of ring back tone in stages. Distance information representing the distance transmitted from the location information server is displayed.

### INCORPORATION BY REFERENCE

This application is based upon and claims the benefit of priority from Japanese Patent Application No. 2007-041035, filed on Feb. 21, 2007, the disclosure of which is incorporated herein in its entirely by reference.

### BACKGROUND OF THE INVENTION

1. Field of the Invention

The present invention relates to a communication terminal capable of carrying out speech and data communication such as a mobile phone, a communication system using the communication terminal, and an information displaying program product and an information displaying method for the communication terminal and more particularly to the communication terminal capable of providing additional service required for speech or data communication, the communication system using the communication terminal, and the information displaying program product and the information displaying method for the communication terminal.

2. Description of the Related Art

In recent years, in addition to communication terminals whose installing location is fixed and using a metal wire line such as a stationary telephone set, fax machine, or a like, mobile-type various communication terminals using wireless technology such as a mobile phone or a like are widely used.

In the case of the communication terminals whose installing location is fixed such as the stationary telephone sets having telephone numbers serving as an address assigned to a number system based on each regional area, only by knowing a telephone number of a party with whom speech or data communication (hereafter simply “communication”) is being carried out, the regional area in which the telephone set is installed can be known. For example, if the telephone number begins with “03”, it shows that its communication terminal is installed in Tokyo. Furthermore, by knowing a number with several digits following the number “03”, it is easy to make a guess in what area in Tokyo the communication terminal is installed. This is because the telephone number is associated with a switching system installed in each regional area.

Therefore, in the case of the communication between the communication terminals being installed in the fixed location, by comparing the telephone number of the communication terminal on a signal sender side or an originator side (hereinafter an “originator terminal”) with that of a communication terminal on a signal receiver side or a call receiver (hereinafter a “receiver terminal”), a rough distance between these terminals can be obtained. For example, if the telephone numbers of both the originator terminal and the receiver terminal begin with the number “03”, it shows that the originator terminal is carrying out communication with the receiver terminal at a distance between two points in Tokyo. If the communication is carried out between the telephone number beginning with 03 and a telephone number beginning with 09, it shows that the communication is carried out between the originator terminal and the receiver terminal at a distance between the Tokyo area and the Kyushu area.

On the other hand, in the communication between the communication terminals using wireless technology, it is not necessary that the communication is carried out through a switching system installed in a fixed manner in each region. Main equipment is provided on the network. Also, in the case of recent stationary telephone sets, the telephone set is used wirelessly except a place where each subscriber home is directly connected directly to the switching system using the metal wire line. Thus, a correlation between the telephone number of the originator terminal and receiver terminal and a regional area decreases and, therefore, even if the telephone numbers are compared with each another, a distance between both terminals cannot be guessed. As a result, whether a person carrying out the communication with each other exists near to each other is not known. When a communication fee is charged depending on a distance, how much communication fee charged is not known until being billed.

To solve this problem, a method is disclosed in Patent Reference 1 (Japanese Patent Application Laid-open No. 2002-330221 [paragraph 0024 to 0029] in which a distance data obtaining section is provided in each of communication terminals to calculate a distance between both terminals.

FIG. 36 is a block diagram showing main components of the related communication system disclosed in Patent Reference 1. In the related communication system, an originator terminal 601 and receiver terminal 602 are connected respectively through base stations 603 and 604 to switching systems 605 and 606. One switching system 605 is connected to a location managing device 607 and another switching system 606 to an HLR (Home Location Register) 608. Both the switching systems 605 and 606 are connected to a mobile communication service determining device 609. The mobile communication service determining device 609 has a distance data obtaining section 611, a communication fee calculating section 612, and a service determining section 613. In the related communication system 614, the distance data obtaining section 611 calculates a distance between both terminals based on location information stored by the location managing device 607 or the HLR 608. The communication fee calculating section 612 calculates a fee by using communication data created relative to a distance. Based on this, the service determining section 613 determines the lowest-priced mobile communication service and notifies the originator terminal 601 of the user on an origination side of the determined price. This enables the user to select the lowest-priced service to make a phone speech.

In the communication system 614, out of a plurality of service choices related to a communication fee, the lowest-priced service corresponding to a distance between both terminals can automatically selected. However, though the selected communication fee is notified to the originator terminal 601 and/or the receiver terminal 602, the distance between both terminals is not notified thereto. Therefore, their users cannot know how far they are carrying out communication from each other. Moreover, in the communication system employing a uniform communication fee system having no relation to a distance in all areas throughout Japan, a concept of a distance from a viewpoint of collection fees is not necessary.

However, when human communication is exchanged among human beings, a distance has a significant meaning. When communication such as speech communication using communication devices is made possible, it is desirous that an environment is maintained where a concept of a distance between communication terminals, for example, the distance at which both the users can meet immediately or at which climates that the two users are living in are greatly different from each other, can be naturally perceived.

### SUMMARY OF THE INVENTION

In view of the above, it is an object of the present invention to provide a communication terminal capable of detecting a distance between communication terminals at a time of carrying out communication, a communication system using the communication terminal, and an information displaying program product and an information displaying method for the communication terminals.

According to a first aspect of the present invention, there is provided a communication terminal including:

(a) a communication terminal specified information transmitting unit to transmit communication terminal specified information for identifying each of communication terminals making up one set of terminals communicating with each other through a network;

(b) a distance information receiving unit to receive distance information when the distance information representing a distance, calculated based on the communication terminal specified information transmitted by the communication terminal specified information transmitting unit, between the one communication terminal and the other communication terminal making up one set is transmitted from the network; and

(c) a distance information displaying unit to display distance information received by the distance information receiving unit.

That is, in the first aspect, the communication terminal is provided with the communication terminal specified information transmitting unit to transmit communication terminal specified information for identifying each of communication terminals making up one set of terminals communicating with each other, which transmits, for example, dial information of one communication terminal and dial information of another communication terminal to which the one communication terminal makes a call to the network. Then, when distance information representing a distance between the one communication terminal and the other communication terminal making up one set of communication terminals described above is transmitted from the network, the receiving terminal receives the dial information and the distance information displaying unit displays the distance information. This enables a distance between communication terminals to be detected while communication is carried out.

According to a second aspect of the present invention, there is provided a communication terminal including:

(a) a communication terminal specified information transmitting unit to transmit communication terminal specified information for identifying each of communication terminals making up one set of terminals communicating with each other through a network;

(b) a location information receiving unit to receive location information when the location information representing a location, obtained based on the communication terminal specified information transmitted by the communication terminal specified information transmitting unit, between the one communication terminal and the other communication terminal making up one set is transmitted from the network;

(c) a distance information calculating unit to calculate a distance between the one communication terminal and the other communication terminal making up one set based on the information received by the location information receiving unit; and

(d) a distance information displaying unit to display information about the distance calculated by the distance information calculating unit.

That is, in the second aspect, the communication terminal is provided with the communication terminal specified information transmitting unit to transmit communication terminal specified information for identifying each of communication terminals making up one set of terminals communicating with each other. Then, when location information representing a location between the one communication terminal and the other communication terminal is transmitted from the network, a distance is calculated based on the transmitted information and the calculated distance information is displayed. This enables a distance between communication terminals to be detected while communication is carried out.

When the distance information is displayed, after setting a plurality of threshold values, the calculated threshold value may be compared with the set threshold values to display the distance information in stages. Also, in the display in stages, a music composition to be outputted as a sound for connection between the one communication terminal and the other communication terminal may be switched depending on the distance or a tempo of a music composition of a ring back tone to be outputted as a sound for connection between the one communication terminal and the other communication terminal may be switched depending on the distance.

According to a third aspect of the present invention, there is provided a communication system including:

(a) a network for communication;

(b) a location information server having a distance calculating unit connected to the network to receive network terminal specified information identifying each of communication terminals making up one set of terminals each carrying out communication with each other through the network to calculate a distance between the communication terminals and a distance calculating result transmitting unit to transmit calculating results obtained by the distance calculating unit as distance information to each of the communication terminals making up one set of terminals; and

(c) communication terminals, each of which includes:

a communication terminal specified information transmitting unit to transmit communication terminal specified information for identifying each of communication terminals making up one set of terminals communicating with each other through a network;

a distance information receiving unit to receive distance information when the distance information representing a distance, calculated based on the communication terminal specified information transmitted by the communication terminal specified information transmitting unit, between the one communication terminal and the other communication terminal making up the one set of terminals is transmitted from the network; and

a distance information displaying unit to display the distance information received by the distance information receiving unit.

That is, in the third aspect, the location information server is connected to the network and, when the communication terminal specified information transmitting unit of the communication terminal transmits communication terminal specified information for identifying each of communication terminals making up one set of terminals communicating with each other to the network, based on this information, distance information is returned. The communication terminal is configured to receive distance information representing a distance between the communication terminal and another communication terminal and to display the received distance information. This enables a distance between communication terminals to be detected while communication is carried out.

According to a fourth aspect of the present invention, there is provided a communication system including:

(a) a network for communication;

(b) a location information server having a location retrieving unit connected to the network to receive network terminal specified information identifying each of communication terminals making up one set of terminals each carrying out communication with each other through the network and to retrieve a location between the communication terminals and a location retrieving result transmitting unit to transmit retrieved results obtained by the location retrieving unit as location information to each of the communication terminals making up one set of terminals; and

(c) communication terminals, each of which includes:

a communication terminal specified information transmitting unit to transmit communication terminal specified information for identifying each of communication terminals making up one set of terminals communicating with each other through a network;

a location information receiving unit to receive location information when the location information representing a location, obtained based on the communication terminal specified information transmitted by the communication terminal specified information transmitting unit, between the one communication terminal and the other communication terminal making up the one set is transmitted from the network;

a distance information calculating unit to calculate a distance between the one communication terminal and the other communication terminal making up the one set based on the information received by the location information receiving unit; and

a distance information displaying unit to display information about the distance calculated by the distance information calculating unit.

That is, in the fourth aspect, the location information server is connected to the network and, when the communication terminal specified information transmitting unit of the communication terminal transmits communication terminal specified information for identifying each of communication terminals making up one set of terminals communicating with each other to the network, based on this information, location information is returned. The communication terminal is configured to receive distance information representing a distance between the communication terminal and another communication terminal and to calculate display a distance and then to display the distance information being calculated results. This enables a distance between communication terminals to be detected while communication is carried out.

According to a fifth aspect of the present invention, there is provided an information displaying program product of communication terminals for making a computer for a communication terminal execute;

(a) a communication terminal specified information transmitting processing of transmitting communication terminal specified information for identifying each of communication terminals making up one set of terminals communicating with each other through a network;

(b) a distance information receiving processing of receiving distance information when the distance information representing a distance, calculated based on the communication terminal specified information transmitted by the communication terminal specified information transmitting processing, between the one communication terminal and the other communication terminal making up one set is transmitted from the network; and

(c) a distance information displaying processing of displaying the distance information received by the distance information receiving processing.

That is, in the fifth aspect, a computer of each of the communication terminals executes control programs to implement the invention described above. This enables a distance between communication terminals to be detected while communication is carried out.

According to a sixth aspect of the present invention, there is provided an information displaying program product of communication terminals for making a computer for a communication terminal execute;

(a) a communication terminal specified information transmitting processing of transmitting communication terminal specified information for identifying each of communication terminals making up one set of terminals communicating with each other through a network;

(b) a location information receiving processing of receiving distance information when the location information representing a location, calculated based on the communication terminal specified information transmitted by the communication terminal specified information transmitting processing, between the one communication terminal and the other communication terminal making up one set is transmitted from the network;

(c) a distance information calculating processing of calculating a distance between the one communication terminal and the other communication terminal making up one set based on the location information received by the location information receiving processing; and

(d) a distance information displaying processing of displaying information about the distance calculated by the distance information calculating processing.

That is, in the sixth aspect, a computer of each of the communication terminals executes control programs to implement the invention also described above. This enables a distance between communication terminals to be detected while communication is carried out.

According to a seventh aspect of the present invention, there is provided an information displaying method including:

(a) a communication terminal specified information transmitting step of transmitting communication terminal specified information for identifying each of communication terminals making up one set of terminals communicating with each other through a network;

(b) a distance information receiving step of receiving distance information when the distance information representing a distance, calculated based on the communication terminal specified information transmitted by the communication terminal specified information transmitting step, between the one communication terminal and the other communication terminal making up one set is transmitted from the network; and

(c) a distance information displaying step of displaying the distance information received by the distance information receiving step.

That is, in the seventh aspect, one communication terminal obtains, through the network, information about a distance between the one communication terminal and another communication terminal carrying out communication with the one communication terminal making up one set of terminals and displays the obtained information and displays the obtained information. This enables a distance between communication terminals to be detected while communication is carried out.

According to an eighth aspect of the present invention, there is provided an information displaying method including:

(a) a communication terminal specified information transmitting step of transmitting communication terminal specified information for identifying each of communication terminals making up one set of terminals communicating with each other through a network;

(b) a location information receiving step of receiving location information when the location information representing a location, calculated based on the communication terminal specified information transmitted by the communication terminal specified information transmitting step, between the one communication terminal and the other communication terminal making up one set is transmitted from the network;

(c) a distance information calculating step of calculating a distance between the one communication terminal and the other communication terminal making up one set based on the information received by the location information receiving step; and

(d) a distance information displaying step of displaying information about the distance calculated by the distance information calculating step.

That is, in the eighth aspect, the one communication terminal obtains, through the network, information about the distance between the one communication terminal and the other communication terminal carrying out communication with the one communication terminal making up the one set of terminals and, based on the obtained information, calculates the distance between the one communication terminal and the other communication terminal carrying out the communication with the one communication terminal and displays the distance information. This enables the distance between the communication terminals to be detected while the communication is carried out.

With the above configuration, the distance calculated based on the distance information and the location information obtained by each of the communication terminals carrying out the communication with each other is displayed by using a method in which five senses of a human such as hearing, eyesight, or a like is stimulated. This enables the user of the communication terminals to detect the distance or a change in the distance in terms of time. Therefore, the present invention can be applied to the case when a person looks for another person whereabouts when meeting for an appointment, when a missing child is searched for, or other cases. The technology of the present invention can be utilized as a new business.

### BRIEF DESCRIPTION OF THE DRAWINGS

The above and other objects, advantages, and features of the present invention will be more apparent from the following description taken in conjunction with the accompanying drawings in which:

FIG. 1 is a diagram showing an overview of a communication system according to a first exemplary embodiment of the present invention;

FIG. 2 is a block diagram showing basic configurations of an originator terminal according to the first exemplary embodiment of the present invention;

FIG. 3 is a block diagram showing an overview of a location information server according to the first exemplary embodiment of the present invention;

FIG. 4 is an explanatory diagram of one example of a ring back tone table according to the first exemplary embodiment of the present invention;

FIG. 5 is a flow chart showing a state of various processing in a ring back tone changing mode to be performed by an originator terminal according to the first exemplary embodiment of the present invention;

FIG. 6 is a flow chart showing a state of ring back tone outputting processing at a time of origination to be performed by the originator terminal according to the first exemplary embodiment of the present invention;

FIG. 7 is a flow chart showing processing of creating distance information to be performed by the location information server according to the first exemplary embodiment of the present invention;

FIG. 8 is a flow chart showing the state of the ring back tone outputting processing to be performed by the receiver terminal on a call receiver side according to the first exemplary embodiment of the present invention;

FIG. 9 is a diagram showing an overview of a communication system according to a second exemplary embodiment of the present invention;

FIG. 10 is a block diagram showing basic configurations of an originator terminal according to the second exemplary embodiment of the present invention;

FIG. 11 is a block diagram showing an overview of a location information server according to the second exemplary embodiment of the present invention;

FIG. 12 is a flow chart showing a state of ring back tone outputting processing at a time of origination to be performed by the originator terminal according to the second exemplary embodiment of the present invention;

FIG. 13 is a flow chart showing processing of creating distance information to be performed by the location information server according to the second exemplary embodiment of the present invention;

FIG. 14 is a flow chart showing a state of ring back tone outputting processing to be performed by the originator terminal on a call receiver side according to the second exemplary embodiment of the present invention;

FIG. 15 is a diagram showing an overview of a communication system according to a third exemplary embodiment of the present invention;

FIG. 16 is a block diagram showing basic configurations of an originator terminal according to the third exemplary embodiment of the present invention;

FIG. 17 is a block diagram showing configurations of a location information server according to the third exemplary embodiment of the present invention;

FIG. 18 is a flow chart showing a state of ring back tone outputting processing at a time of call origination to be performed by the originator terminal according to the third exemplary embodiment of the present invention;

FIG. 19 is a flowchart showing processing of creating distance information to be performed by the location information server;

FIG. 20 is a flow chart showing a state of ring back tone outputting processing at a time of call receiving to be performed by a receiver terminal according to the third exemplary embodiment of the present invention;

FIG. 21 is a diagram showing an overview of a communication system according to a fourth exemplary embodiment of the present invention;

FIG. 22 is a flow chart showing a state of ring back tone outputting processing at a time of call origination by an originator terminal according to the fourth exemplary embodiment of the present invention;

FIG. 23 is a flowchart showing processing of creating location information to be performed by a location information server according to the fourth exemplary embodiment of the present invention;

FIG. 24 is a flow chart showing the state of the ring back tone outputting processing at a time of call receiving by a receiver terminal according to the fourth exemplary embodiment of the present invention;

FIG. 25 is a diagram showing an overview of a communication system according to a fifth exemplary embodiment of the present invention;

FIG. 26 is a block diagram showing basic configurations of an originator terminal according to the fifth exemplary embodiment of the present invention;

FIG. 27 is a block diagram showing an overview of a location information server according to the fifth exemplary embodiment of the present invention;

FIG. 28 is a flow chart explaining contents of processing of an in-communication distance notification mode to be performed by the originator terminal according to the fifth exemplary embodiment of the present invention;

FIG. 29 is a flowchart showing processing of creating distance information to be performed by the location information server according to the fifth exemplary embodiment of the present invention;

FIG. 30 is a flow chart showing processing of looking for location information of the originator terminal to be performed by a location information server in the fifth exemplary embodiment of the present invention;

FIG. 31 is a diagram showing an overview of a communication system according to a sixth exemplary embodiment of the present invention;

FIG. 32 is a block diagram showing basic configurations of an originator terminal according to the sixth exemplary embodiment of the present invention;

FIG. 33 is a block diagram showing configurations of a location information server according to the sixth exemplary embodiment of the present invention;

FIG. 34 is a flow chart explaining contents of processing of an in-communication distance notification mode to be performed by the originator terminal according to the sixth exemplary embodiment of the present invention;

FIG. 35 is a flowchart showing processing of creating distance information to be performed by the location information server according to the sixth exemplary embodiment of the present invention; and

FIG. 36 is a block diagram showing main components of a related communication system.

### DETAILED DESCRIPTION OF THE PREFERRED EXEMPLARY EMBODIMENTS

Best modes of carrying out the present invention will be described in further detail using various exemplary embodiments with reference to the accompanying drawings.

### First Exemplary Embodiment

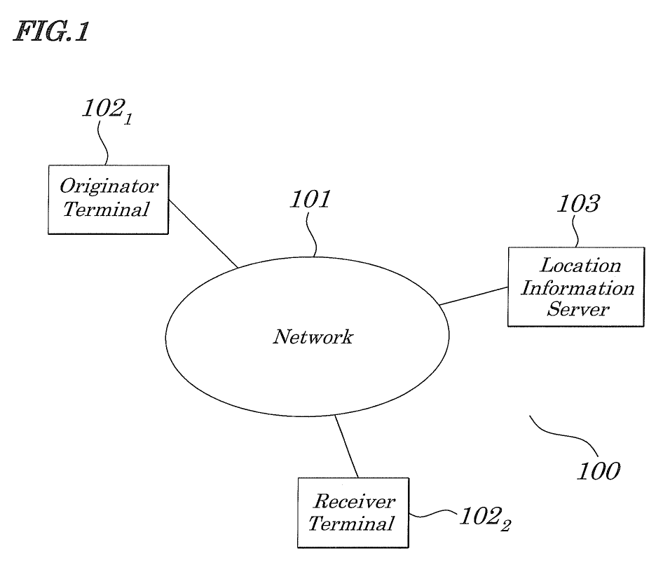

FIG. 1 is a diagram showing an overview of a communication system of the first exemplary embodiment of the present invention. The communication system 100 of the first exemplary embodiment includes a network 101 such as a mobile phone network, the Internet, or a like, a first communication terminal (hereafter an “originator terminal”) 102₁ on an origination side connected to the network 101, a second communication terminal (hereafter a “receiver terminal”) 102₂ on a signal receiving side, and a location information server 103 to manage location information.

Each of the originator terminal 102₁ and receiver terminal 102₂ is made up of communicating devices such as a mobile phone, PHS (Personal Handy-phone System), PDA (Personal Digital Assistant) having a communicating function, portable-type personal computer also with a function of communication, and a like.

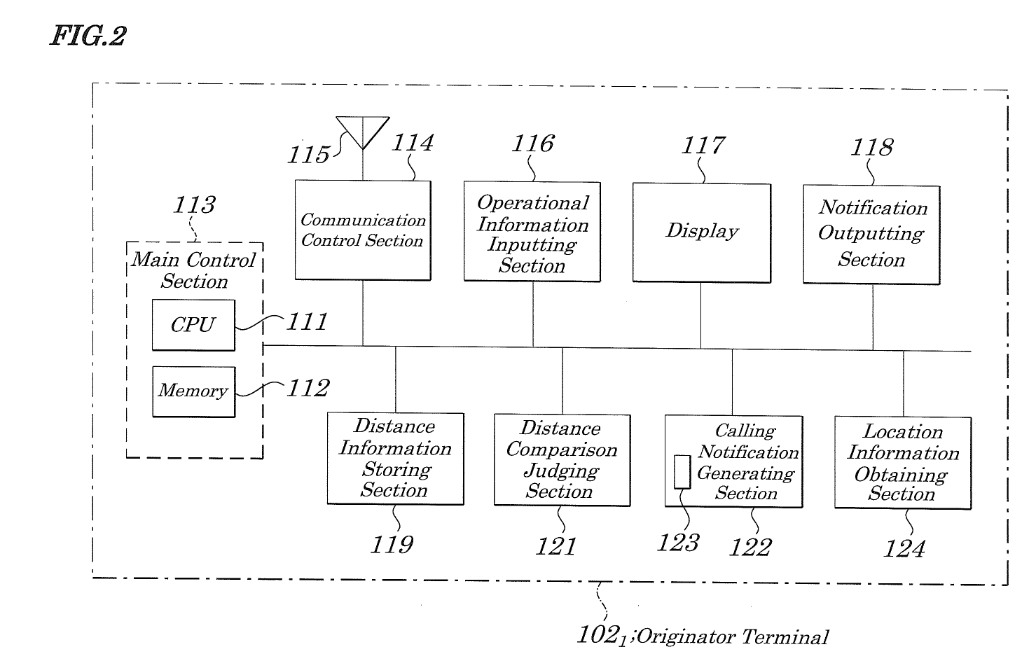

FIG. 2 is a block diagram showing basic configurations of the originator terminal 102₁ of the first exemplary embodiment of the present invention. The receiver terminal 102₂ to be used in the exemplary embodiment (in FIG. 1) has the same configurations as the originator terminal 102₁ and its illustration and description are omitted accordingly.

The originator terminal 102₁ includes a main control section 113 having a CPU (Central Processing Unit) 111 and memory 112 made up of a storing medium such as a ROM (Read Only Memory) storing control programs to be executed by the CPU 111. The main control section 113 is connected to each section in the originator terminal 102₁ as explained below and is configured to exert control on each of these sections. However, at least part of these sections may be implemented by constructing software by which the CPUlll executes control programs.

A communication control section 114 has an antenna 115 and is configured to be connected via a wireless base station (not shown) to the network 101. The communication control section 114, while the originator terminal 102₁ is calling a communicating party, has a function of receiving a notification of the calling. Also, the communication control section 114, while a communicating terminal other than the originator terminal 102₁ is making a call to the communicating party, has a function of receiving a notification of receipt of the calling.

An operational information inputting section 116 is a device by which a user inputs various kinds of operational information for origination or a like. A display 117 is a device to generate a visual display. The display 117 can make a required visual notification using a character or a symbol. A notification outputting section 118 is configured to make a notification using a means which stimulates any one of the five senses of a human including the use of a sound, vibration, lighting of a flash lamp or light emission from a light emitting diode (all being not shown) to provide an additional means for notification, in addition to the notifying methods by the display 117. In the specification of the exemplary embodiment of the present invention, “to make a notification by using the means which stimulates any one of the five senses of a human” is also represented, in a wider sense, as “to display”.

A distance information storing section 119 is configured to store information about a distance between the originator terminal and receiver terminal (in this case, the receiver terminal 102₂) transferred by the location information server 103 (FIG. 1). A distance comparison judging section 121 is configured to compare the stored distance information with a pre-set values (threshold values). A calling notification generating section 122 is configured to generate a notification sound to notify that a call is being made to a communicating party (the party with which the originator terminal is communicating with). In the calling notification generating section 122 is stored a ring back tone setting table 123 described later. A location information obtaining section 124 of the originator terminal 102₁ is configured to obtain location information of the receiver terminal 102₂. The receiver terminal 102₂, if being able to use a GPS (Global Positioning System), determines its own location by using the GPS. As another method for obtaining location information, the communication control section 114 can obtain its location information by using a distance relative to a wireless base station with which communication is now being presently carried out.

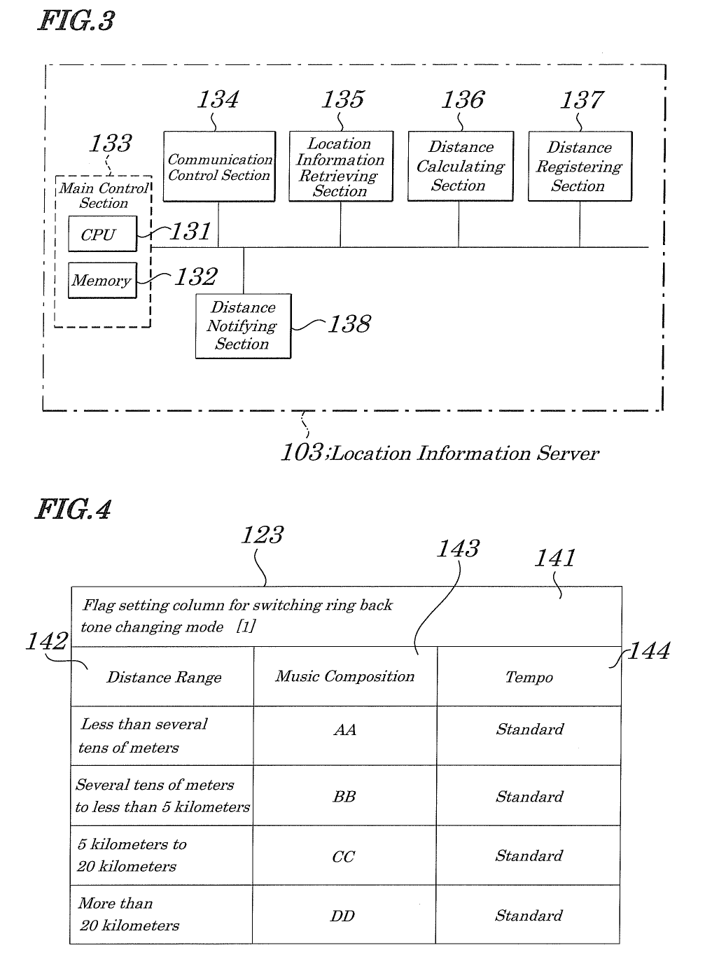

FIG. 3 is a diagram showing an overview of the location information server 103. The location information server 103 includes a main control section 133 having memory 132 made up of a CPU 131 and a storing medium such as a hard disk storing control programs to be executed by the CPU 131. The main control section 131 is connected to each section in the location information as explained below and is configured to exert control on each of the sections. However, at least part of these sections may be implemented by constructing software by which the CPU 131 executes control programs.

The communication control section 134 is ordinarily connected to the network 101 shown in FIG. 1 and configured to carry out communication with various communication terminals such as the originator terminal 102₁, receiver terminal 102₂, or a like. The location information retrieving section 135, when being accessed by the originator terminal 102₁, looks for a location of the receiver terminal 102₂. The distance calculating section 136 calculates a distance between the originator terminal 102₁ and the receiver terminal 102₂. The distance registering section 137 is configured to register a distance between the originator terminal 102₁ and receiver terminal 102₂ calculated by the distance calculating section 136. The distance notifying section 138 is configured to notify the originator terminal 102₁ and the receiver terminal 102₂ of the distance registered in the distance registering section 137.

In the communication system 100 of the exemplary embodiment shown in FIG. 1, when the originator terminal 102₁ originates a call to the receiver terminal 102₂, a ring back tone can be set so that its kind or its tempo (hereafter also called a “kind of a ring back tone” if appropriate) is made to differ in several stages depending on a distance between the originator terminal 102₁ and the receiver terminal 102₂. This is the same as in the case of a ring back tone made when the receiver terminal 102₂ receives a call. A user of each of the originator terminal 102₁ and receiver terminal 102₂ can set information about whether or not the execution of the ring back tone changing mode is allowed, a distance range, and a kind of a ring back tone in the ring back tone setting table 123 shown in FIG. 2.

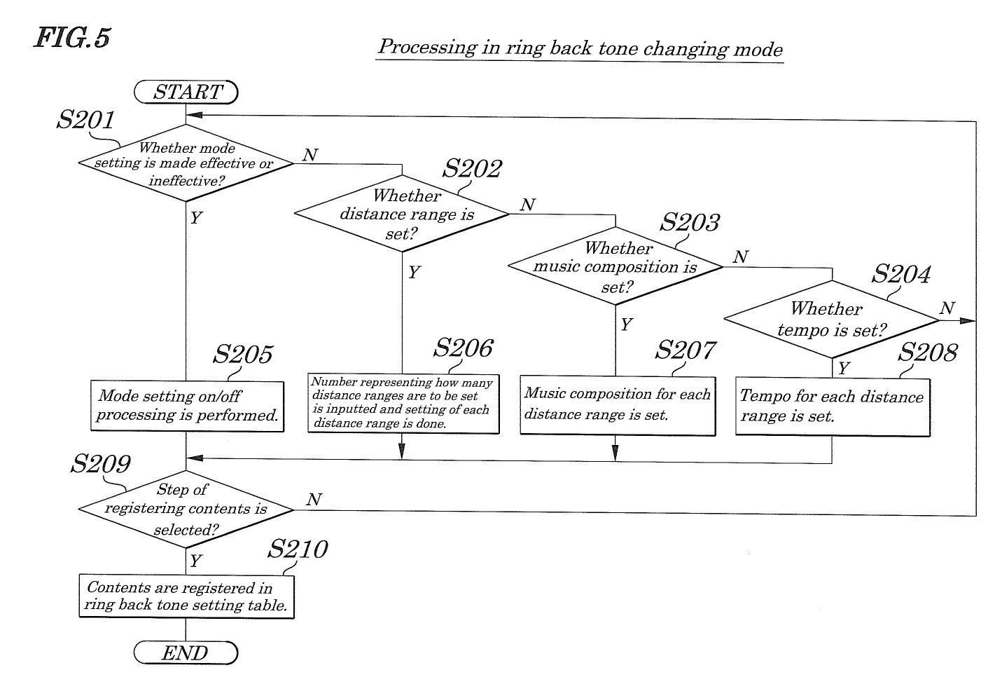

FIG. 4 is a diagram explaining one example of a ring back tone setting table. The ring back tone table 123 includes a flag setting column 141 showing whether or not the execution of the ring back tone changing mode is allowed, a column for a distance range 142 between the originator terminal 102₁ and receiver terminal 102₂, a column 143 for a music composition to be set to each distance range, and a column 144 for a music composition tempo. The value “1” is set for the flag setting column 141 when the execution of the ring back tone changing mode is allowed and the value “0” is set when the execution of the ring back tone changing mode is not allowed.

In the column for the distance range 142, a default value is set as an initial value, however, a user is allowed to change the default value. It is needless to say that setting of a small distance range within a specified limit is meaningless. For the column for a music composition 143, as a default value, “AA” . . . “DD” are set, however, a user is allowed to buy a music composition through the Internet from a provider of music compositions or to create a music composition and to set the bought or created composition for a appropriate column within the distance range 142. It is not necessary that the music composition 143 is music or melody. A message to be suggestive of a distance range such as being “nearest” or being “more than 20 kilometers” is acceptable.

The tempo 144 represents a speed of regenerating music compositions 143. By selecting melody, as the music composition” of a bell sound regenerated repeatedly at one-second intervals at a standard tempo for every distance range and by changing a repetition period for an individual distance range, a user is made to recognize a present distance range. One example is shown below. The bell sound regenerated repeatedly at 2 second intervals is made to correspond to “more than 20 kilometers”, the bell sound regenerated repeatedly at 1 second intervals to correspond to “5 kilometers to 20 kilometers”, the bell sound regenerated repeatedly at 0.5 second to correspond to the “several tens of meters to less than 5 kilometers” and the bell sound regenerated repeatedly at 0.25 second to correspond to “less than several tens of meters” being the smallest range. Thus, by setting the same music or melody as the music composition 143 but by changing its tempo 144, a user is made to feel a sense of distances.

FIG. 5 is a flow chart showing states of various processing in the ring back tone changing mode to be performed by an originator terminal of the first exemplary embodiment of the present invention. A user of the originator terminal 102₁ shown in FIG. 1 switches a menu screen (not shown) to the ring back tone changing mode to perform the setting process. Moreover, in the receiver terminal 102₂ shown in FIG. 1, the same processing as in the originator terminal 102₁ is performed and their descriptions are omitted accordingly.

When a mode is moved to the ring back tone changing mode, a screen for choices appears in the display 117 shown in FIG. 2 to make a selection as to whether mode setting is made effective or ineffective (Step S201), whether a distance range is set (or changed) (Step S202), whether a music composition is set (or changed) (Step S203), whether a tempo of the music composition is set (or changed) (Step S204). When the screen for the choice is selected to make a selection as to whether mode setting is made effective or ineffective (Step S201:Y), mode setting on/off processing is performed to let a flag in the flag setting column 141 shown in FIG. 3 become “1” or “0” (Step S205).

The user, when selecting the screen for choices to set (or change) a distance range (Step S202:Y), inputs the number representing how many distance ranges are to be set and does setting of each distance range (Step S206). If, as a factory-set default value, four kinds of distance ranges are set as shown in FIG. 4, the distance ranges can be changed from the four kinds to, for example, two kinds, or each distance range can be changed.

The user, when selecting the screen for choices to set a music composition (Step S203:Y), can select a music composition corresponding to each distance range and can change the music composition already selected (Step S207). Also, the user, when selecting the screen for choices to set (or change) a tempo (Step S204:Y), can select a tempo corresponding to each distance range and can change the tempo already selected (Step S208).

After each setting or each processing has been performed (Step S205 to S208), the screen for choices appears to make a selection as to whether or not contents of the setting or processing are registered and, if a step of registering the contents is selected (Step S209:Y), current set contents are registered in the ring back tone setting table 123 (Step S210) and the processing for setting is terminated (END). The user is allowed to make the routine return back to a process of setting other items (Step S201 to Step S204) without performing the process of registering for every item (Step S209: N). In this case, after the completion of all setting processes, registration for setting is made.

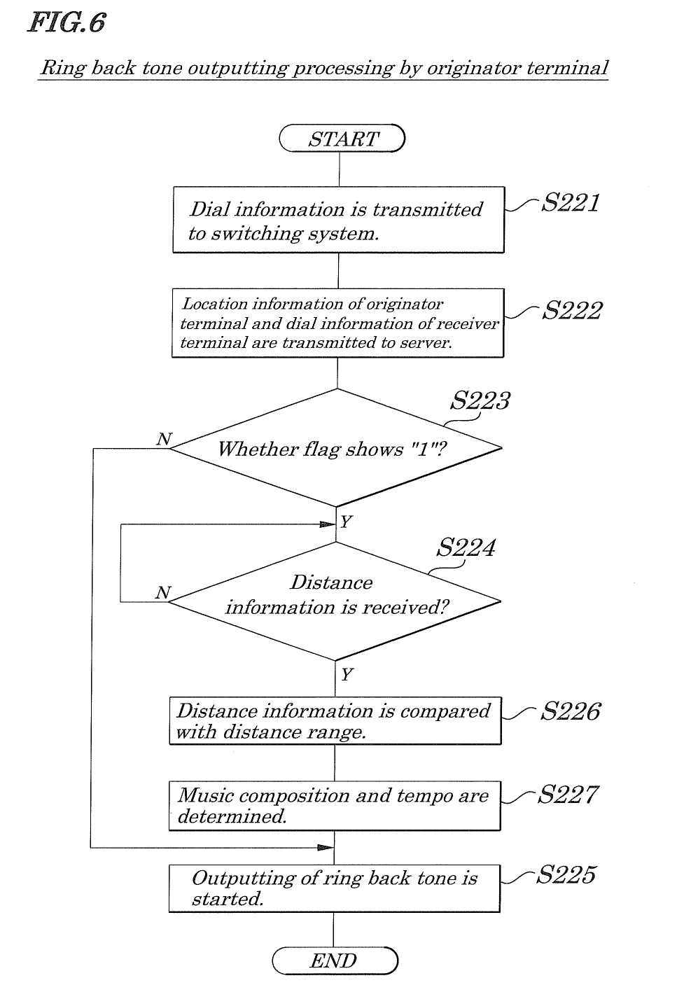

FIG. 6 is a flow chart showing states of the ring back tone outputting processing at a time of call origination by the originator terminal of the first exemplary embodiment of the present invention. Its description is made by referring also to FIGS. 1 and 2. The originator terminal 102₁ obtains dial information of the receiver terminal 102₂ from the operational inputting section 116 and, as an originating operation, transmits the obtained information to a switching system (not shown) (Step S221). Next, location information of the originator terminal 102₁ and dial information of the receiver terminal 102₂ are transmitted from the location information obtaining section 124 of the originator terminal 102₁ via the network 101 being in a connected state to the location information server 103 (Step S222).

Then, the originator terminal 102₁ judges whether or not the value “1” is set for the flag setting column 141 in the ring back tone setting table 123 shown in FIG. 4 (Step S223). When the value “1” representing that the execution of the ring back changing tone is allowed is set (Step S223:Y), the originator terminal 102₁ waits for a return of distance information from the location information server 103 (Step S224). On the other hand, when the value “0” representing that the execution of the ring back tone changing mode is not allowed is set (Step S223:N), outputting of the ring back tone is immediately started (Step S225).

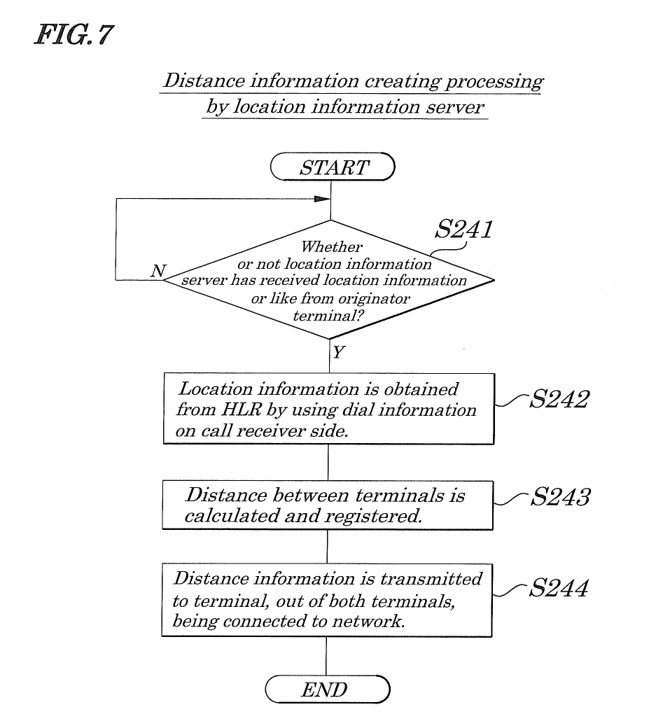

FIG. 7 is a flow chart showing processing of creating distance information to be performed by the location information server. Its description is made also referring to FIGS. 1 and 3. The location information server 103 waits for the receipt of location information of the originator terminal 102₁ on the origination side and dial information of the receiver terminal 102₂ (Step S241) on the receiving side from the originator terminal 102₁. When these pieces of information have been received by the processing at the Step S222 in FIG. 6 (Step S241: Y), the location information retrieving section 135 obtains the location information of the receiver terminal 102₂ on the call receiver side by using the dial information obtained from a home location register (HLR) (not shown) (Step S242).

Moreover, at this time point, the switching system has already obtained the location information by the above same way by using the dial information of the receiver terminal 102₂ on the call receiver side for call receiving. Therefore, the location information of the receiver terminal 102₂ has been renewed to be the newest one. In some cases, the receiver terminal 102₂ is out of service area where radio waves do not reach and, if so, the location information of the receiver terminal 102₂ is treated as an error.

When the location information of the receiver terminal 102₂ is obtained at the Step S242, the distance calculating section 136 of the originator terminal 102₁ calculates a distance between the originator terminal 102₁ and receiver terminal 102₂ and registers the results from the calculation in the distance registering section 137 (Step S243). If the receiver terminal 102₂ is out of service area where radio waves do not reach, the results from the calculation is treated as an error.

The distance information representing the distance between the originator terminal 102₁ and receiver terminal 102₂ (including the information about calculation results treated as an error) registered in the distance registering section 137 is transmitted via the network 101 to these terminals (Step S244). If the receiver terminal 102₂ is out of service area where radio waves do not reach or is turned off, information is not transmitted to the receiver terminal 102₂.

The description is continued again by referring to FIG. 6. The originator terminal 102₁, when receiving the distance information from the location information server 103 (Step S224: Y), compares the distance information with information stored in the ring back tone setting table 123 (Step S226). Then, the originator terminal 102₁ determines a ring back tone by reading a corresponding distance range, music composition, and its tempo (Step S227). Thereafter, outputting of the ring back tone is started (Step S225).

Therefore, the user of the originator terminal 102₁ while hearing the ring back tone, can judge whether the receiver terminal 102₂ is located near or far. As a result, when a communication fee differs depending on a distance, the user is allowed to make an effort to shorten the telephone speech to reduce the fee. Moreover, when the receiver terminal 102₂ is out of service area where radio waves do not reach or is turned off, the distance information of the receiver terminal 102₂ is treated as an error, causing no outputting of the ring back tone, resulting in no need for the comparison (Step S226) of the distance information with the information stored in the ring back tone table 123.

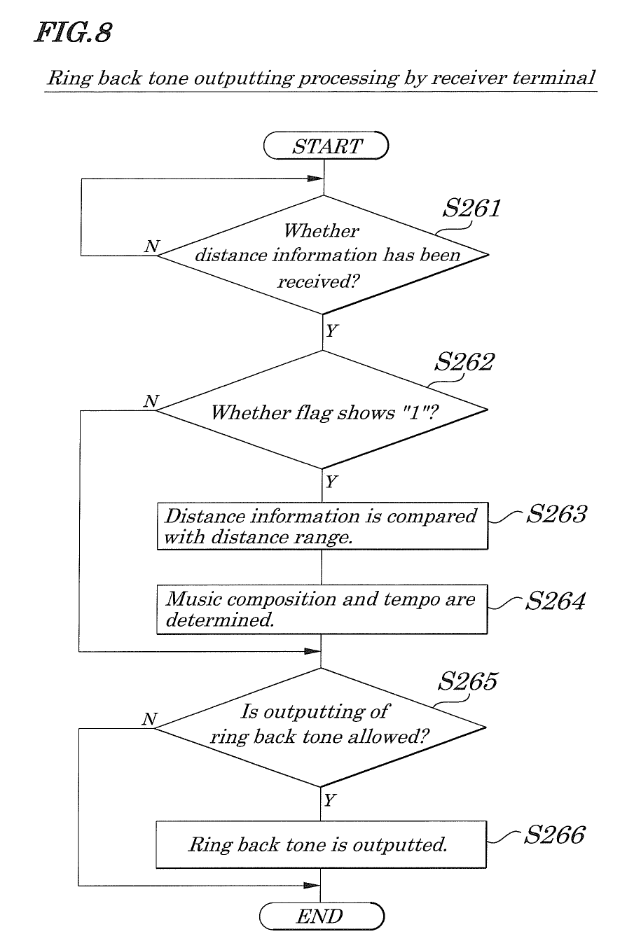

FIG. 8 is a flow chart showing a state of a ring back tone outputting processing to be performed by the receiver terminal on the call receiver side of the first exemplary embodiment of the present invention. Its description is made again by referring to FIGS. 1 and 2, and FIG. 4. Moreover, FIG. 2 shows configurations of the originator terminal 102₁ but, in this description, the configurations in FIG. 2 are handled as those of the receiver terminal 102₂. Also, FIG. 4 shows the ring back setting table 123 of the originator terminal 102₁ but, in this description, the ring back tone setting table in FIG. 4 is handled as that of the receiver terminal 102₂.

The receiver terminal 102₂, when receiving distance information from the location information server 103 (Step S261:Y), judges whether the value “1” has been set for the flag setting column 141 in the ring back tone table 123 of the receiver terminal 102₂ (Step S262). If the value “1” representing that the execution of the ring back tone changing mode is allowed is set (Y), the transmitted distance information is compared with the distance range 142 stored in the ring back tone setting table 123 of the receiver terminal 102₂ (Step S263). Then, a corresponding music composition and corresponding tempo are read out to determine a ring back tone (Step S264). If the state of the receiver terminal 102₂ at this time point represents that the outputting of a ring back tone is allowed (Step S265: Y), the outputting of the music composition and tempo determined at the Step S264 is started (Step S266). If the state of the receiver terminal 102₂ at this time point represents that the outputting of a ring back tone is not allowed (Step S265: N), the ring back tone is not outputted and the process is terminated (END).

On the other hand, if the value “0” is set for the flag setting column 141 of the ring back tone setting table 123 at the Step S262, it means that the user of the receiver terminal 102₂ does not desire the execution of the ring back tone changing mode. Therefore, if so (N), the routine immediately proceeds to the Step S265.

In the first exemplary embodiment described above, the location information server 103 is treated as a device different from the switching system. However, when the location information server 103 and the switching system can be used commonly, it is natural that the processing shown in FIGS. 6 to 8 can be changed in each case. This is the same for the case where the location information server 103 and the home location register are commonly used.

Also, in the first exemplary embodiment, the location information obtaining section 124 is configured to obtain location information which is notified to the location information server 103, however, the location information server 103 maybe configured to obtain location information by using a home location register as in the case of the receiver terminal 102₂. Moreover, as in the case where the location information server 103 and switching system are commonly used, when the location information server 103 can exchange data with the receiver terminal 102₂ at a time of receiving signals, the location information server 103 may be configured to obtain the location information from the receiver terminal 102₂.

According to the first exemplary embodiment explained above, the user of each of the originator terminal 102₁ and the receiver terminal 102₂ can easily judge a distance between both terminals by hearing a ring back tone. Therefore, the user of the originator terminal 102₁ and the receiver terminal 102₂, when meeting someone for an appointment, can easily detect a change in distance between the originator terminal 102₁ and the receiver terminal 102₂ by periodically sending out the ring back tone.

### Second Exemplary Embodiment

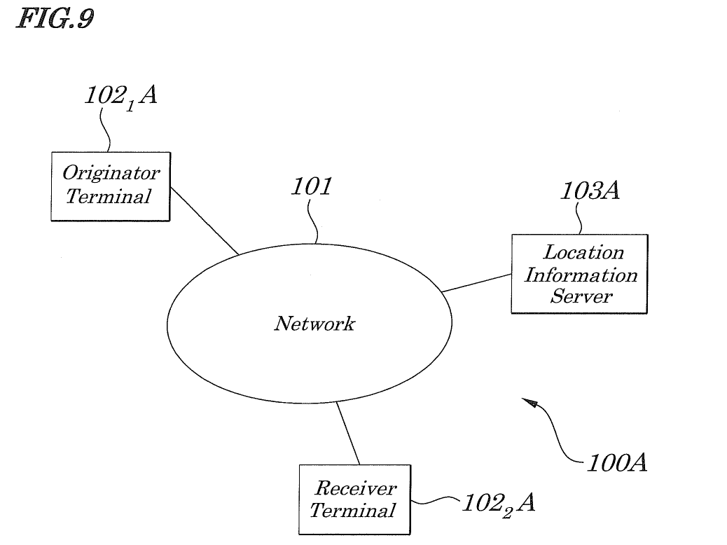

FIG. 9 is a diagram showing an overview of a communication system of the second exemplary embodiment of the present invention. The communication system 100A of the second exemplary embodiment includes a network 101 such as a mobile phone network, the Internet, or a like, an originator terminal 102₁A serving as a first communication terminal on an originator side connected to the network 101, a receiver terminal 102₂A serving as a second communication terminal on a signal receiver side, and a location information server 103A to manage location information.

Each of the originator terminal 102₁A and receiver terminal 102₂A is made up of communicating devices such as a mobile phone, PHS, PDA having a communicating function, portable-type personal computer also with a function of communicating, or a like.

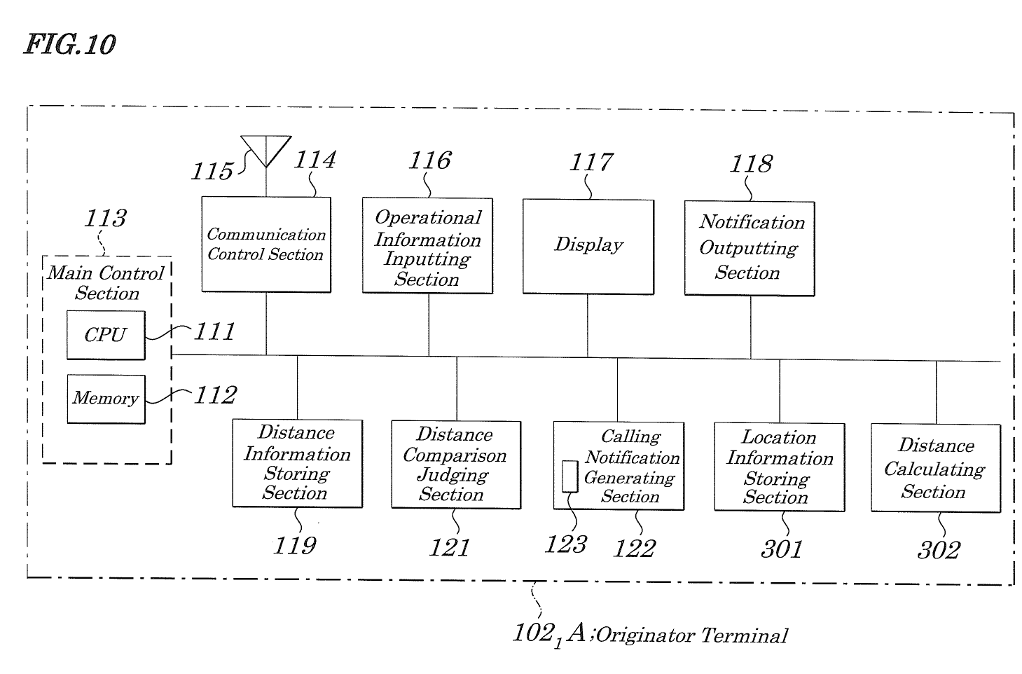

FIG. 10 is a block diagram showing basic configurations of the originator terminal of the second exemplary embodiment of the present invention. The receiver terminal 102₂A employed in the second exemplary embodiment (FIG. 9) has the same configurations as the originator terminal 102₁A and their illustration and descriptions are omitted accordingly. Moreover, the same reference number is assigned to each of circuits of the originator terminal 102₁A being the same as those of the originator terminal 102₁ employed in the first exemplary embodiment and their descriptions are omitted, if appropriate, accordingly.

The originator terminal 102₁A of the second exemplary embodiment doe not receive distance information between the originator terminal 102₁A and receiver terminal 102₂A but location information of both the originator terminal 102₁A and receiver terminal 102₂A from the location information server 103A. Therefore, the originator terminal 102₁A has a location information storing section 301 instead of the location information obtaining section 124 (FIG. 2) of the first exemplary embodiment. Also, the originator terminal 102₁A has a distance calculating section 302 to calculate a distance between the originator terminal 102₁A and receiver terminal 102₂A from the received location information of both the originator terminal 102₁A and receiver terminal 102₂A.

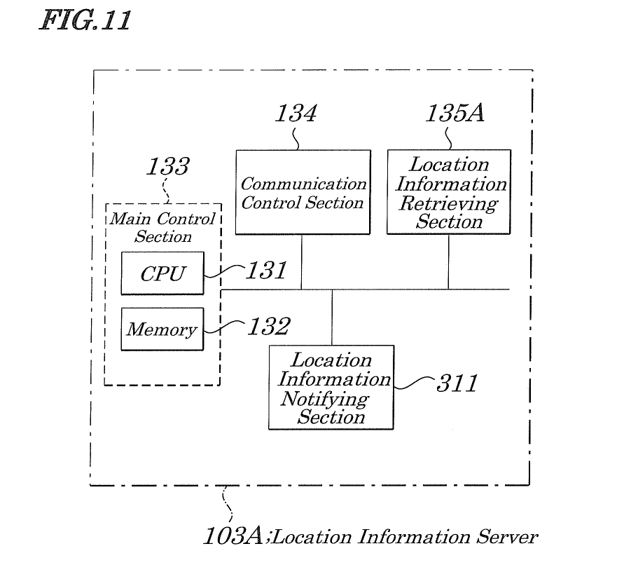

FIG. 11 is a block diagram showing an overview of a location information server of the second exemplary embodiment of the present invention. The location information server 103A includes a location information retrieving section 135A to obtain location information of both the originator terminal 102₁A and receiver terminal 102₂A and a location information notifying section 311 to notify both the terminals of the location information.

Each of the originator terminal 102₁A and receiver terminal 102₂A of the second exemplary embodiment has a ring back tone setting table 123 shown in FIG. 4 and performs setting processing of distance information shown in FIG. 5. Therefore, FIGS. 4 and 5 are used also for the description of the second exemplary embodiment.

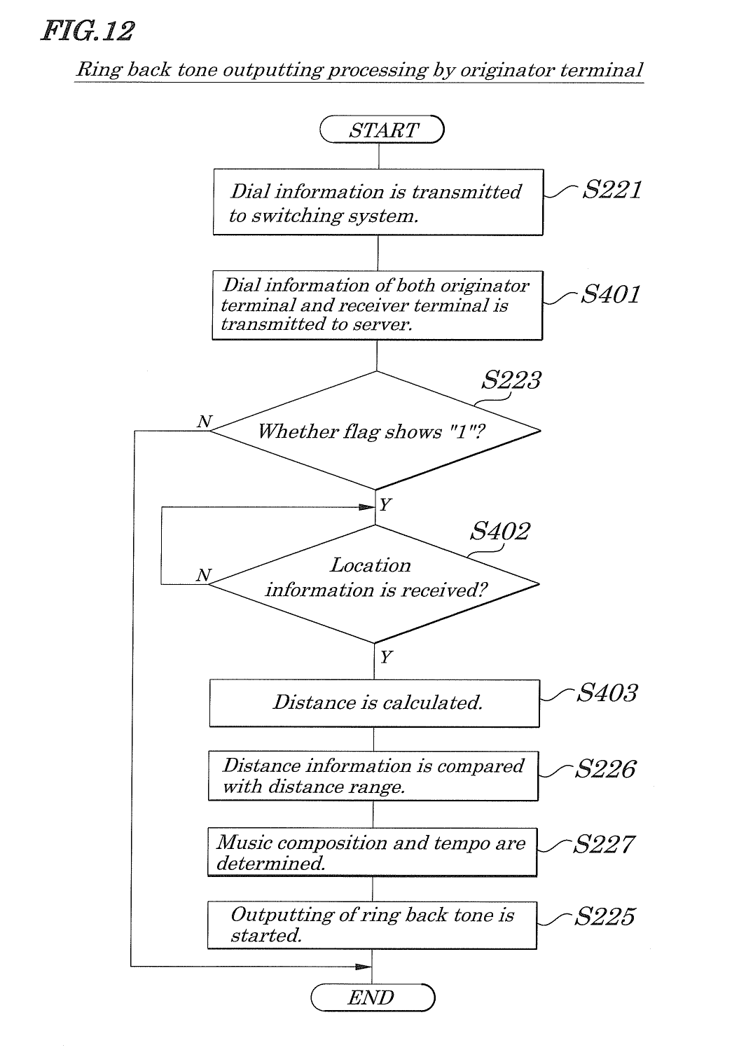

FIG. 12 is a flow chart showing states of ring back tone outputting processing at a time of origination by an originator terminal of the second exemplary embodiment of the present invention. Its description is made also by referring to FIGS. 9 and 10. In FIG. 12, the same step number is assigned to the same processing as in FIG. 6.

The originator terminal 102₁A obtains dial information of the receiver terminal 102₂A from the operational information inputting section 116 and transmits the obtained information, as an origination operation, to the switching system (not shown) (Step S221). Next, the originator terminal 102₁A transmits dial information of both the originator terminal 102₁A and receiver terminal 102₂A via the network 101 to which the originator terminal 102₁A is connected to the location information server 103A (Step S401). The originator terminal 102₁A judges whether the value “1” is set for the flag setting column in the ring back setting table shown in FIG. 4 (Step S223). When the value “1” representing that the execution of the ring back tone changing mode is allowed is set (Step S223: Y), the originator terminal 102₁A waits for the return of location information of the location information server 103A (Step S402). On the contrary, if the value “0” representing that the execution of the ring back tone changing mode is not allowed is set (Step S223: N), the outputting of the ring back tone is immediately started (Step S225).

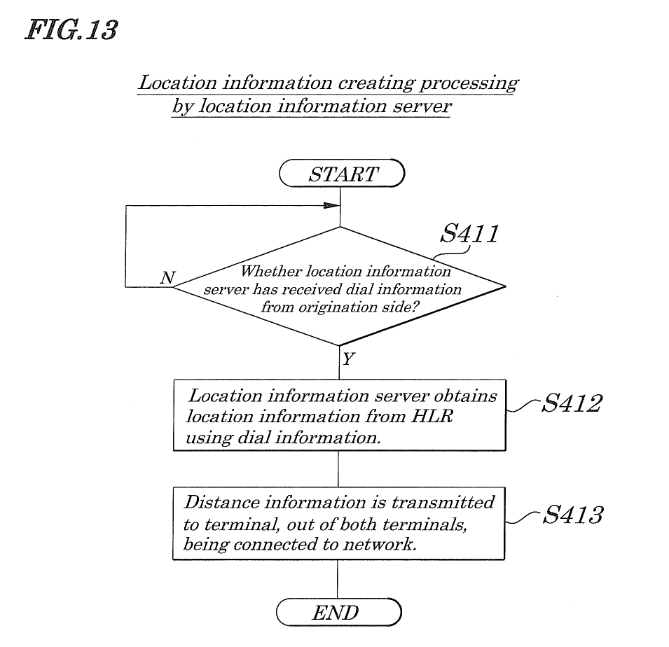

FIG. 13 is a flow chart showing processing of creating distance information by the location information server 103A of the second exemplary embodiment of the present invention. Its description is made also by referring to FIGS. 9 and 11.

The location information server 103A waits the receipt of dial information of the originator terminal 102₁A and the receiver terminal 102₂A from the originator terminal 102₁A serving as an originator (Step S411). When the location information server 103A receives dial information by the processing at the Step S401 in FIG. 12 (Y), the location information retrieving section 135A of the location information server 103A obtains location information of the originator terminal 102₁A and the receiver terminal 102₂A from the home location register (not shown) (Step S412).

Moreover, at this time point, the switching system has already obtained the location information by using the dial information of the receiver terminal 102₂A on the call receiver side in the same manner. Therefore, the location information of the receiver terminal 102₂A has been renewed to be the newest. If the receiver terminal 102₂A is out of service area where radio waves do not reach, the location information of the receiver terminal 102₂A is treated as an error.

When the location information server 103A obtains location information of the originator terminal 102₁A and the receiver terminal 102₂A at the Step S412, the location information notifying section 311 of the location information server 103A transmits the information (containing the information about calculation results treated as an error) through the network 101 to both the terminals (Step S413). If the receiver terminal 102₂A is out of service area where radio waves do not reach or is turned off, no information is transmitted to the terminal accordingly.

Its description is made also by referring to FIG. 12. When the originator terminal 102₁A receives location information from the location information server 103A (Step S402:Y), the distance calculating section 302, based on the location information, calculates a distance between the originator terminal 102₁A and the receiver terminal 102₂A (Step S403). Then, the obtained distance information is compared with contents of the ring back tone setting table 123 shown in FIG. 4. A music composition and tempo corresponding to a distance range are read out to determine a ring back tone (Step S227). Thereafter, outputting of the ring back tone is started (Step S225).

Therefore, a user of the originator terminal 102₁A, while hearing the ring back tone, can judges whether the receiver terminal 102₂A is located near or far. As a result, when a communication fee differs depending on a distance, the user is allowed to make an effort to shorten the telephone speech to reduce the fee. Moreover, when the receiver terminal 102₂A is out of service area where radio waves do not reach or is turned off, the distance information of the receiver terminal 102₂A is treated as an error and no ring back tone is outputted, resulting in no need for the comparison (Step S226) of the distance information with the information in the ring back tone table 123.

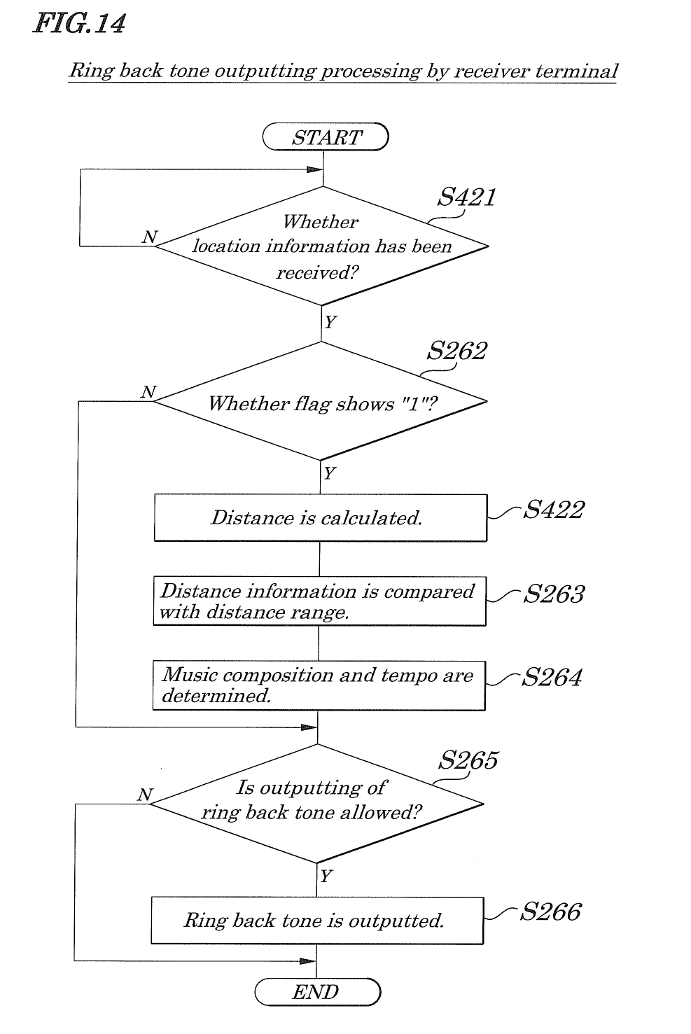

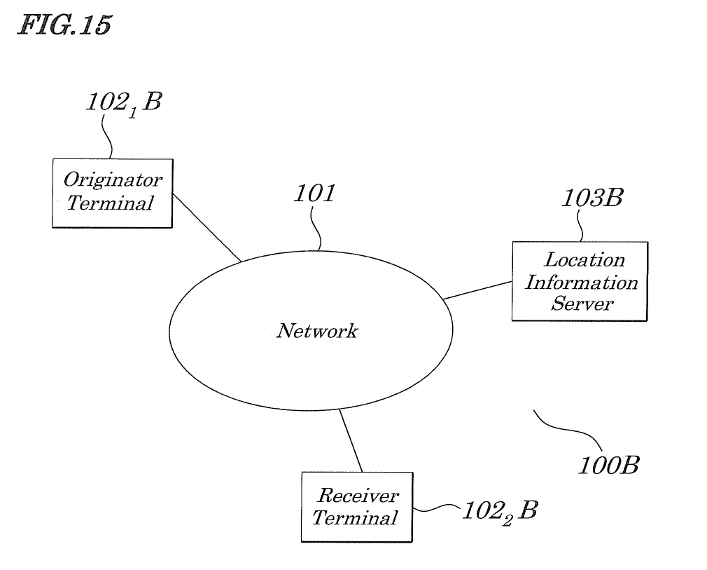

FIG. 14 is a flow chart showing states of ring back tone outputting processing by the originator terminal on the call receiver side of the second exemplary embodiment of the present invention. Its description is made by referring to FIGS. 9 and 10 and FIG. 4. In FIG. 14, the same step number is assigned to the same processing as in FIG. 8. Moreover, FIG. 10 shows configurations of the originator terminal 102₁ of the first exemplary embodiment but, in this description, the configurations in FIG. 14 are treated as those of the receiver terminal 102₂A.

The receiver terminal 102₂A, when receiving location information from the location information server 103A (Step S421: Y), judges whether the value “1” is set for the flag setting column 141 in the ring back tone setting table of the receiver terminal 102₂A (Step S262). When the value “1” representing that the execution of the ring back changing tone is allowed is set (Step S422:Y), the receiver terminal 102₂A calculates, based on the setting, a distance between the originator terminal 102₁A and the receiver terminal 102₂A (Step S422) is calculated. Then, the obtained distance information is compared with the distance range 142 stored in the ring back tone table 123 of the receiver terminal 102₂A (Step S263). A music composition and tempo are read out to determine a ring back tone (Step S264). At this time point, if the receiver terminal 102₂A is in a state where the outputting of a ring back tone is allowed (Step S265: Y), the outputting of the music composition and tempo determined at the Step S264 is started (Step S266). If the outputting of the ring back tone is not allowed (Step S265:N), the processing is terminated without outputting the ring back tone.

On the contrary, if the value “0” is set for the flag setting column 141 in the ring back tone setting table 123, it means that the user of the receiver terminal 102₂A does not desire the execution of the ring back tone changing mode. Therefore, in this case (N), the routine immediately proceeds to the Step S265.

In the second exemplary embodiment described above, the location information server 103A is treated as a device different from the switching system. However, when the location information server 103A and the switching system can be used commonly, it is natural that the processing shown in FIGS. 12 to 14 can be changed in each case. This is the same for the case where the location information server 103A and the home location register are commonly used.

According to the second exemplary embodiment described above, a user of each of the originator terminal 102₁A and receiver terminal 102₂A can easily judge a distance between both terminals by hearing a ring back tone. Therefore, a user, when meeting someone for an appointment, can easily detect a change in distance between the originator terminal 102₁A and receiver terminal 102₂A by periodically sending out a ring back tone. Moreover, when compared with the first exemplary embodiment, the calculation of a distance by the location information server 103B is not required and, therefore, loads on the device can be reduced.

### Third Exemplary Embodiment

FIG. 15 is a diagram showing an overview of a communication system of the third exemplary embodiment of the present invention. The communication system 100B of the third exemplary embodiment includes a network 101 such as a mobile phone network, the Internet, a like, an originator terminal 102₁B serving as the first communication terminal on an originator side connected to the network 10, a receiver terminal 102₂B serving as the second communication terminal on a signal receiver side, and a location information server 103B to manage location information.

Each of the originator terminal 102₁B and receiver terminal 102₂B is made up of communicating devices such as a mobile phone, PHS, PDA having a communicating function, portable-type personal computer also with a function of communicating, or a like.

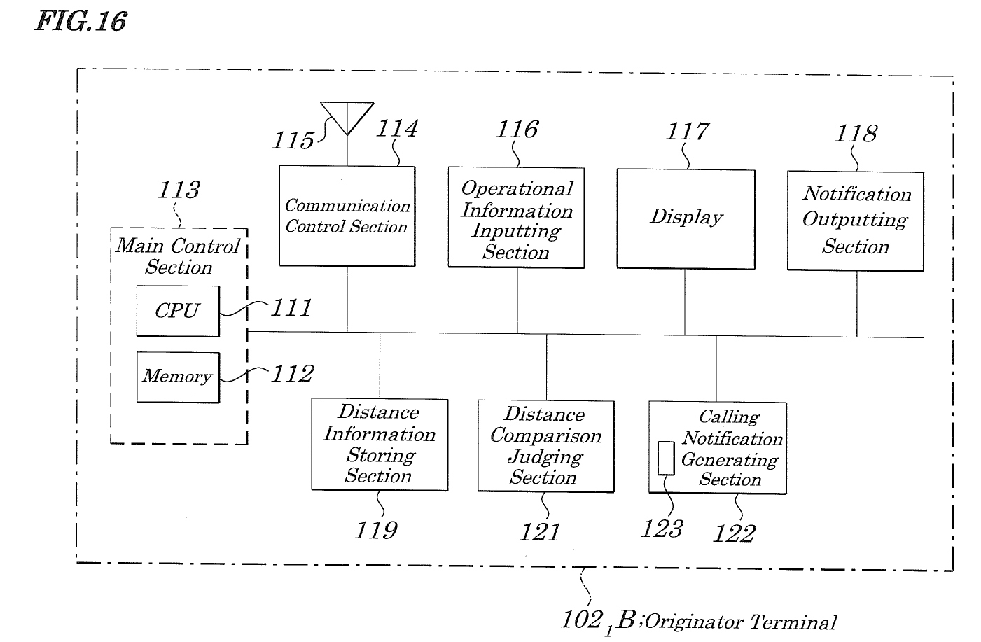

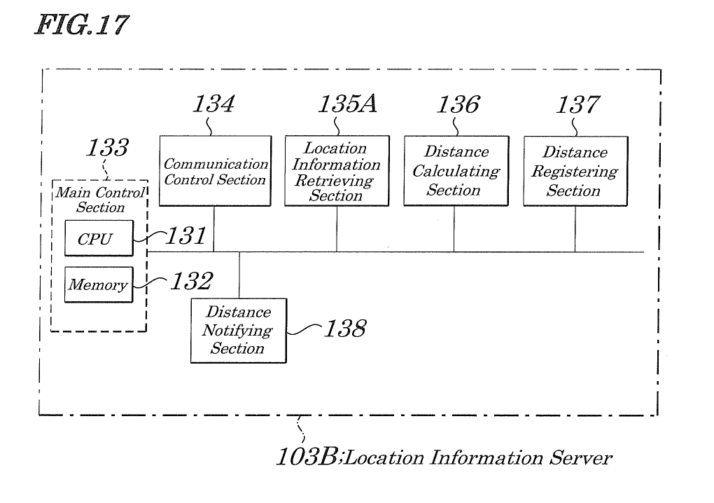

FIG. 16 is a block diagram showing basic configurations of the originator terminal of the third exemplary embodiment of the present invention. The receiver terminal 102₂B employed in the third exemplary embodiment (FIG. 15) has the same configurations as the originator terminal 102₁B and their illustration and descriptions are omitted accordingly. Moreover, in FIG. 16, the same reference number is assigned to each of circuits of the originator terminal 102₁B being basically the same as those of the originator terminal 102₁ employed in the first exemplary embodiment and their descriptions are omitted, if appropriate, accordingly.

The originator terminal 102₁B of the third exemplary embodiment receives information about a distance between the originator terminal 102₁B and the receiver terminal 102₂B from the location information server 103B as in the case of the first exemplary embodiment. However, as in the case of the second exemplary embodiment, the originator terminal 102₁B itself need not obtain its own location information. Therefore, the originator terminal 102₁B of the third exemplary embodiment has no location information obtaining section 124 shown in FIG. 2.

FIG. 17 is a block diagram showing configurations of a location information server of the third exemplary embodiment of the present invention. The location information server 103B of the third exemplary embodiment differs from the location information server 103 of the first exemplary embodiment in that the location information retrieving section 135A is provided which is configured to obtain location information of both the originator terminal 102₁B and the receiver terminal 102₂B. The configurations of the location information server 103B are the same as the location information server 103 in that the distance between the originator terminal 102₁B and receiver terminal 102₂B is calculated from the location information of the originator terminal 102₁B and receiver terminal 102₂B. Therefore, the configurations of the location information server 103B of the third exemplary embodiment are the same as the location information server 103 except that operations of the location information retrieving section 135A of the third exemplary embodiment are different from those of the location information server 103 of the first exemplary embodiment.

Moreover, also in the third exemplary embodiment, each of the originator terminal 102₁B and receiver terminal 102₂B has a ring back tone setting table 123 as shown in FIG. 4 and processing of setting distance information shown in FIG. 5 is performed. Therefore, FIGS. 4 and 5 are used for the description of the third exemplary embodiment.

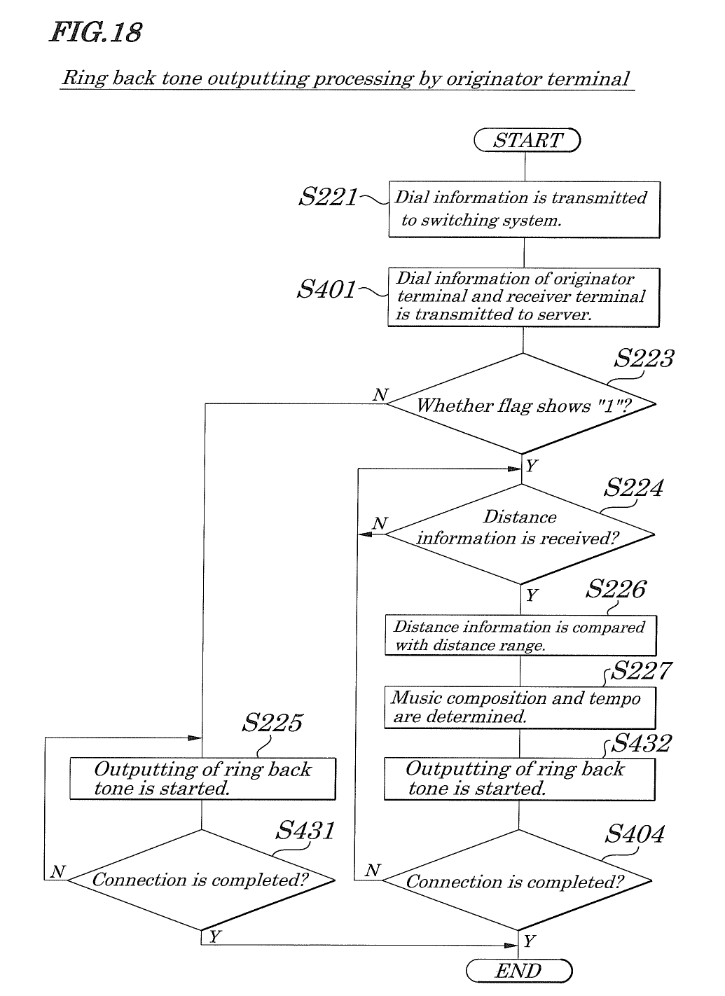

FIG. 18 is a flow chart showing a state of ring back tone outputting processing at a time of origination to be performed by the originator terminal of the third exemplary embodiment of the present invention. Its description is made also by referring to FIGS. 15 and 16. In FIG. 18, the same reference number is assigned to processes being the same as those in FIG. 6 or FIG. 12.

The originator terminal 102₁B obtains dial information of the receiver terminal 102₂B from the operational information inputting section 116 and, as an originating operation, transmits the obtained information to a switching system (not shown) (Step S221). Next, the originator terminal 102₁B transmits dial information of the originator terminal 102₁B and receiver terminal 102₂B via the network 101 to which the originator terminal 102₁B is connecting to the location information server 103B (Step S401). Then, the originator terminal 102₁B judges whether or not the value “1” is set for the flag setting column 141 in the ring back tone setting table 123 shown in FIG. 4 (Step S223). When the value “1” representing that the execution of the ring back changing tone is allowed is set (Step S223:Y), the originator terminal 102₁B waits for a return of distance information from the location information server 103B (Step S224). On the other hand, when the value “0” representing that the execution of the ring back tone changing mode is not allowed is set (Step S223: N), outputting of the ring back tone is immediately started (Step S225). The outputting of the ring back tone continues until a user of the receiver terminal 102₂B answers the phone and the connection is completed (Step S431).

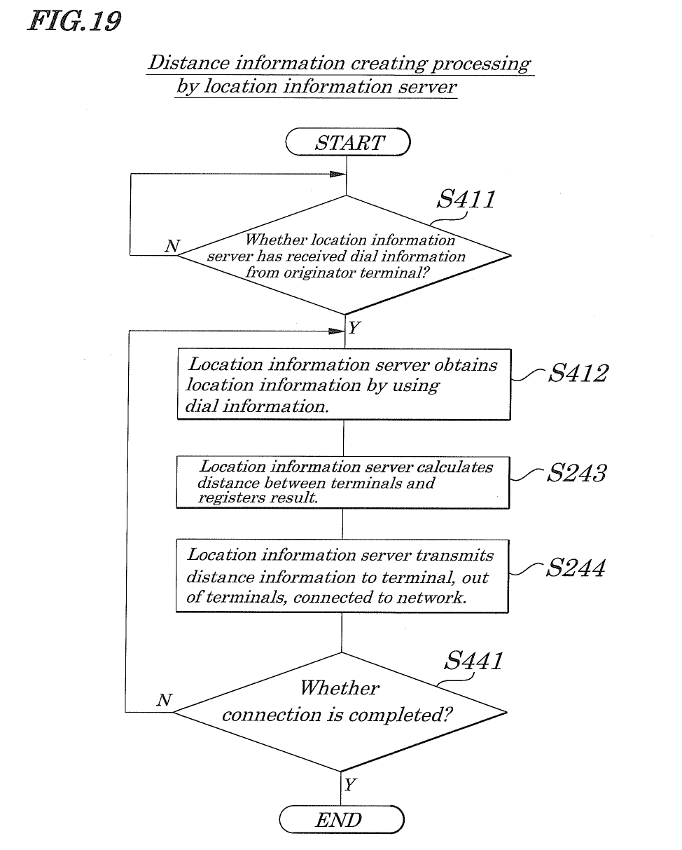

FIG. 19 is a flow chart showing processing of creating distance information to be performed by the location information server 103B. Its description is made also by referring to FIGS. 15 and 17. In FIG. 19, the same reference number is assigned to processes being the same as those in FIG. 7 or FIG. 13.

The location information server 103B waits for receipt of dial information of the originator terminal 102₁B as a call originator and receiver terminal 102₂B (Step S411) from the originator terminal on the originator side. When the dial information is received by the processing at the Step S401 (Y), the dial location information retrieving section 135A, by using the information, obtains location information of the originator terminal 102₁B and receiver terminal 102₂B from a home location register (not shown)(Step S412).

Moreover, at this time point, the switching system has already obtained the location information by a retrieving process using the dial information of the receiver terminal 102₂B on the call receiver side. Therefore, the location information of the receiver terminal 102₂B has been renewed to be the newest one. In some cases, the receiver terminal 102₂B is out of service area where radio waves do not reach and, if so, the location information of the receiver terminal 102₂B is treated as an error.

When the distance information of the originator terminal 102₁B and receiver terminal 102₂B is obtained, the distance calculating section 136 calculates, by using the obtained location information, a distance between the originator terminal 102₁B and receiver terminal 102₂B and registers the calculated result in the distance registering section 137 (Step S243). When the receiver terminal 102₂B is out of service area where radio waves do not reach, the results from the calculation are treated as an error.

The distance information (including the information of calculation results treated as an error) representing a distance between the originator terminal 102₁B and receiver terminal 102₂B registered in the distance registering section 137 is transmitted to these terminals (Step S244). If the receiver terminal 102₂B is out of service area where radio waves do not reach or is turned off, no information is transmitted to the receiver terminal 102₂B.

After the processing at the Step S244, the location information server 103B checks whether the receiver terminal 102₂B answers the phone and the connection between both terminals are completed (Step S441:Y). Then, when the connection is not completed and outputting of a ring back tone has to be continued (N), the location information server 103B lets the routine return back to the Step S412 to again obtain location information of the originator terminal 102₁B and receiver terminal 102₂B from the home location register. Based on this information, a distance between both terminals is calculated (Step S243) and the processing of transmitting distance information to these terminals is repeated (Step S441: N). This is because the case where the distance between the originator terminal 102₁B and the receiver terminal 102₂B is changed while the receiver terminal 102₂B is being called, in some cases, is taken into consideration.

The description is continued again by referring to FIG. 18. The originator terminal 102₁B, when receiving distance information from the location information server 103B (Step S224:Y), compares the received distance information with contents of the ring back tone table 123 shown in FIG. 4 (Step S226). Then, a music composition and its tempo in a corresponding distance range are read out to determine a ring back tone (Step S227). After this, the determined ring back tone is outputted (Step S432).

Then, the originator terminal 102₁B checks whether the receiver terminal 102₂B answers the phone and connection is completed (Step S404). When the connection for speech is not yet completed (N), the originator terminal 102₁B lets the routine return back to the Step S224. Each time the originator terminal 102₁B receives distance information (Y), the distance information is compared with contents of the ring back tone setting table 123 shown in FIG. 4 (Step S226) and, if the distance is changed, corresponding music composition or tempo are changed according to the change of the distance (Step S227). When a change occurs, the ring back tone changed according to the changed content is outputted (Step S432). When the distance between the originator terminal 102₁B and receiver terminal 102₂B is changed due to the repetition of the above processing occurring until the completion of connection while a ring back tone is making a calling sound, the ring back tone changes depending on the change, which enables a user to readily recognize the change in distance.

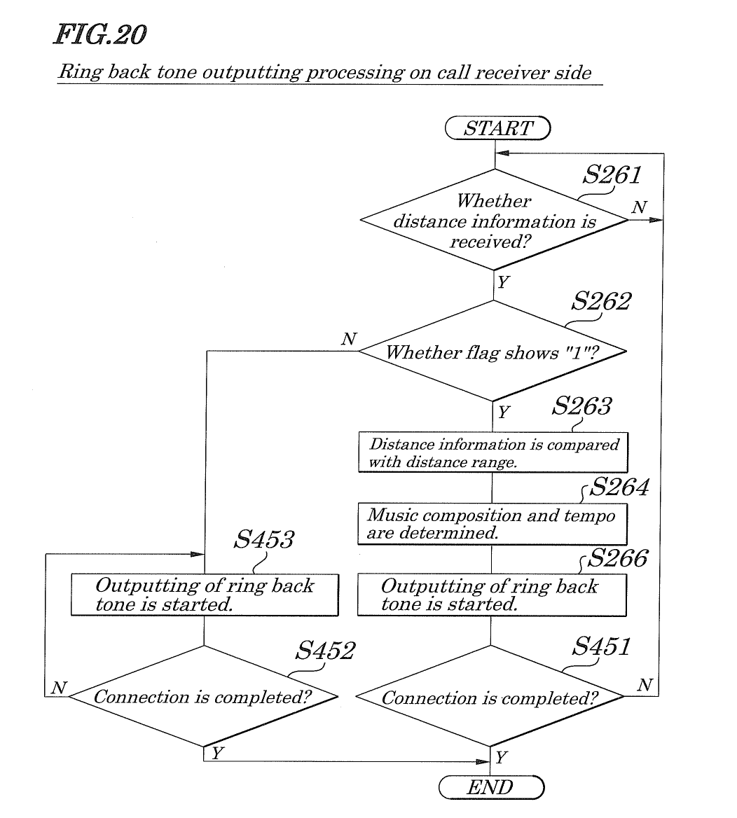

FIG. 20 is a flow chart showing a state of ring back tone outputting processing at a time of call receiving to be performed by an originator terminal of the third exemplary embodiment of the present invention. Its description is made by referring to FIGS. 15 and 16 and FIG. 4. Moreover, FIG. 16 shows configurations of the originator terminal 102₁B but, in this description, the configurations in FIG. 16 are treated as those of the receiver terminal 102₂B. Also, the ring back tone table 123 in FIG. 4, in this description, is treated as the ring back tone of the receiver terminal 102₂B. In FIG. 20, the same step number is assigned to the same processing as in FIG. 8.

The receiver terminal 102₂B, when receiving distance information from the location information server 103B (Step S261:Y), judges whether the value “1” is set for the flag setting column 141 of the ring back tone setting table 123 of the receiver terminal 102₂B (Step S262). When the value “1” representing that the execution of the ring back changing tone is allowed is set (Step S262:Y), the transmitted distance information is compared with distance range 142 in the ring back tone setting table 123 of the receiver terminal 102₂B (Step S263). Then, a corresponding music composition and its tempo are read out to be determined (Step S264). Next, the ring back tone is outputted using the music composition and tempo determined by the processing at the Step S264.

Then, whether or not the receiver terminal 102₂B answers the phone and the connection is completed is checked (Step S451). When the connection is completed (Y), all processes end and outputting of the ring back tone is terminated (END). Until the connection is terminated (Step S451:N), the routine returns back to the Step S261 to wait for the receipt of distance information. While distance information is being transferred from the location information server 103B, the distance information is compared with contents of the ring back tone setting table 123 shown in FIG. 4 (Step S263) and, if the distance is changed, a corresponding music composition and tempo are changed according to the distance change (Step S264) and a ring back tone is outputted according to the contents of the change (Step S266) When the distance between the originator terminal 102₁B and receiver terminal 102₂B is changed due to the repetition of the above processing until the completion of connection while a ring back tone is making a calling sound, the ring back tone is changed depending on the distance change, thus enabling user's easy recognition of the distance change.

On the other hand, if the value “0” has been set for the flag setting column 141 of the ring back tone setting table 123 at the Step S262, it means that a user of the receiver terminal 102₂B does not desire the execution of the ring back tone changing mode. Therefore, in this case (N), until the connection is completed (Step S452:N), the old ring back tone is outputted (Step S453).

Moreover, when the receiver terminal 102₂B is out of service area where radio waves do not reach or is turned off and distance information becomes an error, the ring back tone is not outputted and, therefore, the comparison processing (Step S226) using the ring back tone setting table 123 is not required.

In the third exemplary embodiment, the location information server 103B is handled as a device different from the switching system. However, when the location information server 103B and the switching system can be used commonly, it is natural that the processing shown in FIGS. 18 to 20 can be changed in each case. This is the same for the case where the location information server 103B and the home location register are commonly used.

According to the third exemplary embodiment explained above, the user of each of the originator terminal 102₁B and the receiver terminal 102₂B can easily judge the distance between the terminals by hearing a ring back tone. Therefore, the user, when meeting someone for an appointment, can easily detect a change in the distance between the originator terminal 102₁B and receiver terminal 102₂B by periodically sending out a ring back tone. Moreover, when compared with the first exemplary embodiment, the calculation of a distance by the location information server 103B is not required and, therefore, loads on the device can be reduced. No acquirement of location information of the originator terminal 102₁B is required and, therefore, no processing of this acquirement is needed.

Furthermore, in the third exemplary embodiment, while a call is being made to the receiver terminal 102₂B, the distance between the originator terminal 102₁B can be continuously detected.

### Fourth Exemplary Embodiment

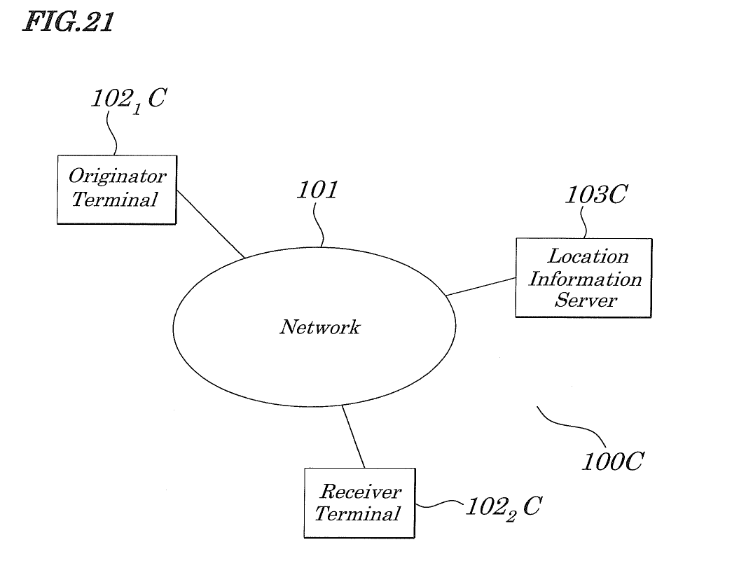

FIG. 21 is a diagram showing an overview of a communication system of the fourth exemplary embodiment of the present invention. The communication system 100C of the fourth exemplary embodiment includes a network 101 such as a mobile phone network, the Internet, or a like, an originator terminal 102₁C serving as a first communication terminal on an originator side connected to the network 101, a receiver terminal 102₂C serving as a second communication terminal on a signal receiver side, and a location information server 103C to manage location information.

Each of the originator terminal 102₁C and receiver terminal 102₂C is made up of communicating devices such as a mobile phone, PHS, PDA having a communicating function, portable-type personal computer also with a function of communicating, or a like.

According to the communication system 100C of the fourth exemplary embodiment, the location information server 103C is configured to retrieve location information of each of the originator terminal 102₁C and the receiver terminal 102₂C and notifies the terminals of the results. Each of the originator terminal 102₁C and the receiver terminal 102₂C calculates a distance between both terminals based on location information thus obtained. Therefore, the configuration of each of the originator terminal 102₁C and the receiver terminal 102₂C of the fourth exemplary embodiment is the same as that of the originator terminal 102₁A shown in FIG. 10 except that their control programs are partially different from each other. Also, the configuration of the location information server 103C is the same as that of the location information server 103A of the second exemplary embodiment shown in FIG. 11 except that their control programs are partially different from each other. Therefore, the illustrations of the originator terminal 102₁C and the receiver terminal 102₂C are omitted and FIGS. 10 and 11 are used to explain these terminals.

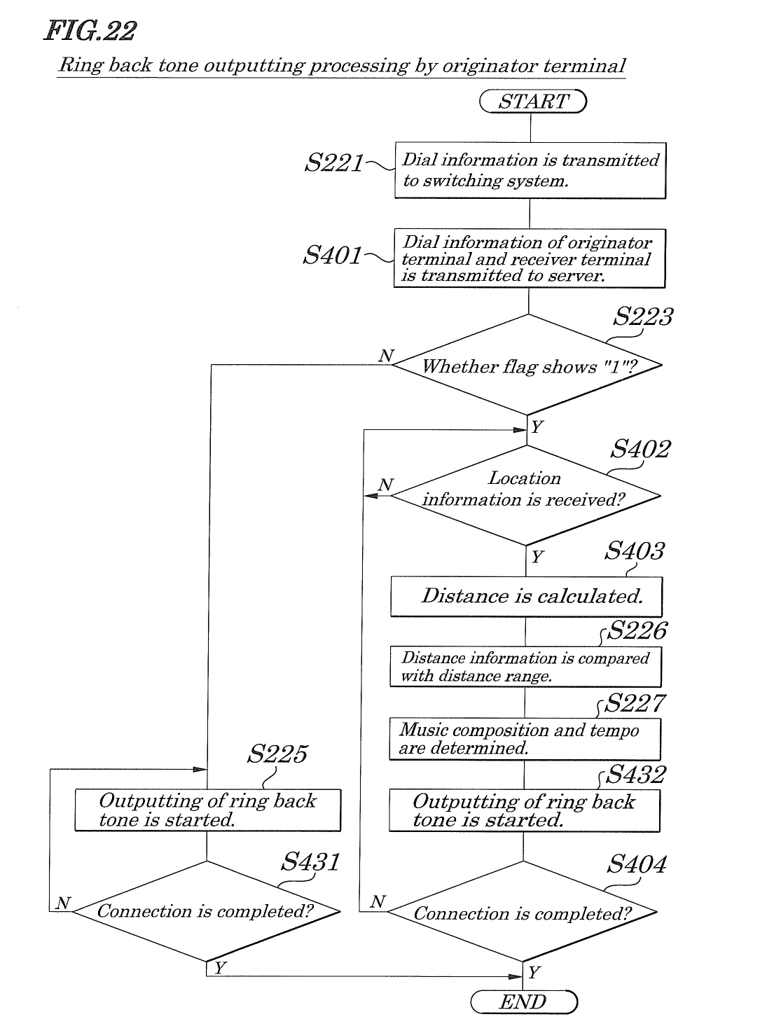

FIG. 22 is a flow chart showing a state of ring back tone outputting processing at a time of call origination by an originator terminal 102₁C of the fourth exemplary embodiment of the present invention. Its description is made by referring to FIGS. 21 and 10. In FIG. 22, the same step numbers are assigned to the same processing as in FIG. 12 or 18.

The originator terminal 102₁C obtains dial information of the receiver terminal 102₂C from the operational information inputting section 116 and, as an originating operation, transmits the obtained information to a switching system (not shown) (Step S221). Next, the originator terminal 102₁C transmits dial information of the originator terminal 102₁C and the receiver terminal 102₂C via the network 101 to which the originator terminal 102₁C is connecting to the location information server 103C (Step S401).

Then, the originator terminal 102₁C judges whether or not the value “1” is set for the flag setting column 141 in the ring back tone setting table 123 shown in FIG. 4 (Step S223). When the value “1” representing that the execution of the ring back tone changing mode is allowed is set (Step S223:Y), the originator terminal 102₁C waits for a return of location information from the location information server 103C (Step S402).

On the other hand, when the value “0” representing that the execution of the ring back tone changing mode is not allowed is set (N), outputting of the ring back tone is immediately started (Step S225). The outputting of the ring back tone continues until a user of the receiver terminal 102₂C answers the phone and the connection is completed (Step S431).

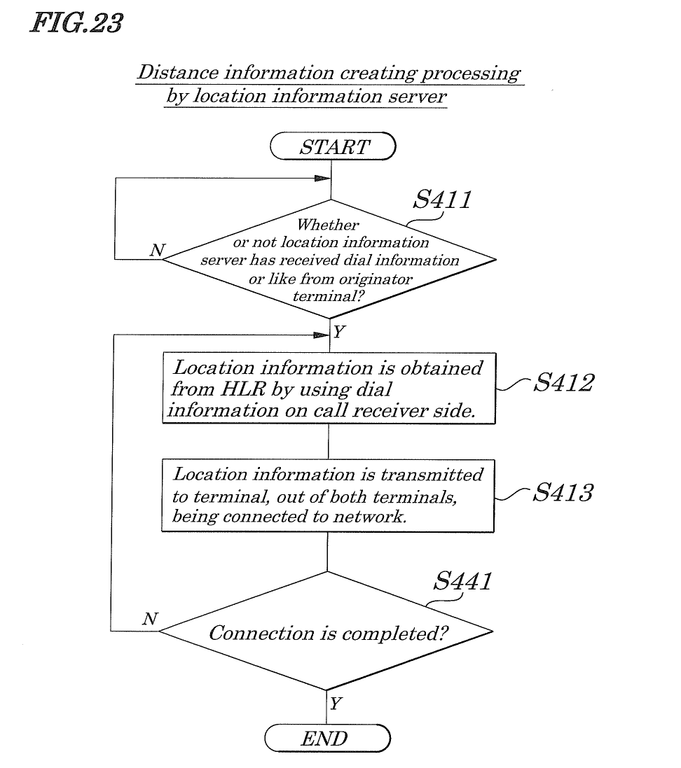

FIG. 23 is a flow chart showing processing of creating location information to be performed by the location information server of the fourth exemplary embodiment of the present invention. Its description is made by referring to FIGS. 21 and 11. In FIG. 23, the same step number is assigned to the same processing as in FIG. 13 or 19.

The location information server 103C waits for the receipt of dial information of the originator terminal 102₁C and the receiver terminal 102₂C from the originator terminal 102₁C on the originator side. When these pieces of dial information have been received by the processing at the Step S₄₀₁ in FIG. 22 (Step S411: Y), the location information retrieving section 135A obtains the location information of the receiver terminal 102₂C on the call receiver side by using the dial information from a home location register (HLR) (not shown) (Step S412).

Moreover, at this time point, the switching system has already obtained the location information in the same way as above by using the dial information of the receiver terminal 102₂C on the call receiver side for call receiving. Therefore, the location information of the receiver terminal 102₂C has been renewed to be the newest one. In some cases, the receiver terminal 102₂C is out of service area where radio waves do not reach and, if so, the location information of the receiver terminal 102₂C is treated as an error.

When the location information server 103A obtains location information of the originator terminal 102₁C and the receiver terminal 102₂C at the Step S412, the location information notifying section 311 of the location information server 103C transmits the location information (containing the information about calculation results treated as an error) through the network 101 to both the terminals (Step S413). If the receiver terminal 102₂C is out of service area where radio waves do not reach or is turned off, no information is transmitted to the receiver terminal 102₂C accordingly.

After the processing is performed at the Step S413, the location information server 103C checks whether the receiver terminal 102₂C answers the phone and connection between both terminals is completed. Then, if the connection is not completed and outputting of a ring back tone has to be continued (N), the location information server 103B lets the routine return back to the Step S412 to again obtain location information of the originator terminal 102₁C and the receiver terminal 102₂C from the home location register. Thus, the processing (Step S413) of transmitting the information to the originator terminal 102₁C and the receiver terminal 102₂C is repeated (Step S441:N). This is because the case where the distance between the originator terminal 102₁C and the receiver terminal 102₂C is changed while the receiver terminal 102₂C is being called, in some cases, is taken into consideration.

The description is continued again by referring to FIG. 22. When the originator terminal 102₁C receives the location information from the location information server 103C (Step S402: Y), the distance calculating section 302 calculates the distance between the originator terminal 102₁C and the receiver terminal 102₂C based on the received location information (Step S403). The calculated distance information is compared with the contents of the ring back tone setting table 123 (Step S226). From the comparison result, the corresponding music composition and tempo are read out to determine a ring back tone (Step S227). Thereafter, outputting of the ring back tone is started (Step S432).

After the above processing, the originator terminal 102₁C checks whether the receiver terminal 102₂C answers the phone and the connection between both terminals are completed (Step S404). Then, when the connection for speech is not completed (N), the originator terminal 102₁C lets the routine return back to the Step S402. Every time the location information is received (Y), the distance between the originator terminal 102₁C and the receiver terminal 102₂C is calculated (Step S403) and the calculated distance information is compared with contents of the ring back tone setting table shown in FIG. 4 and, if the distance is changed, the corresponding music composition and tempo are so changed depending on the changed distance (Step S432). Therefore, if the change occurs in the music composition or its tempos, the ring back tone is outputted according to the changed contents. When the distance between the originator terminal 102₁C and receiver terminal 102₂C is changed due to the repetition of the above processes until the connection is completed while the ring back tone is being produced, the ring back tone changes depending on the change in distance, which enables the user to readily recognize the change in the distance.

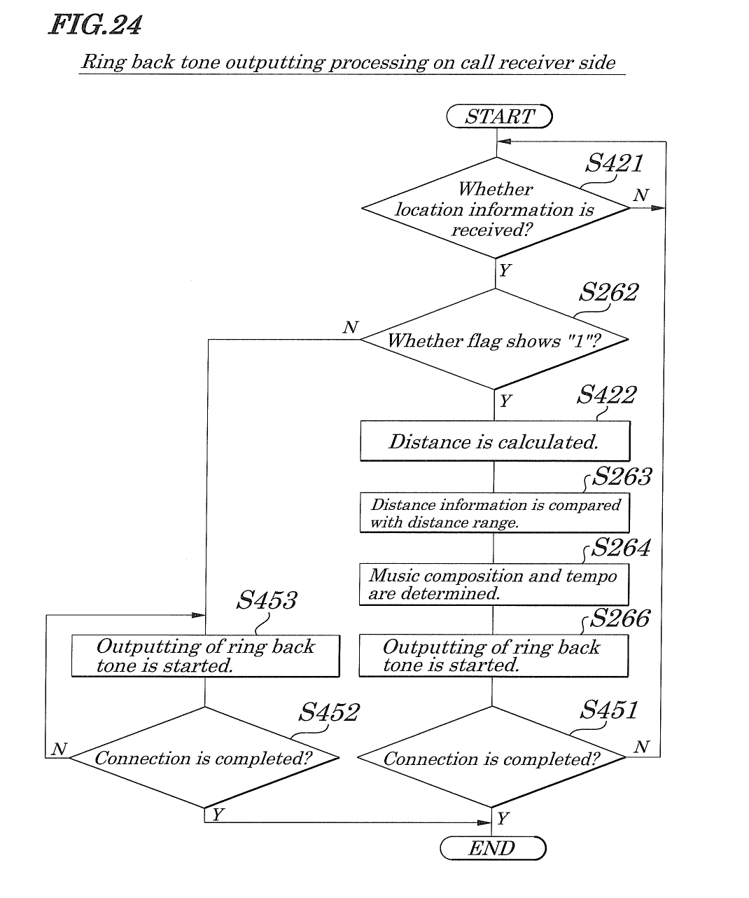

FIG. 24 is a flow chart showing a state of ring back tone outputting processing at a time of call receiving to be performed by the receiver terminal of the fourth exemplary embodiment of the present invention. The description is made by referring to FIGS. 21 and 10, and FIG. 4. Moreover, FIG. 10 shows configurations of the originator terminal 102₁C, however, in this description, the configurations in FIG. 10 are treated as those of the receiver terminal 102₂C. Also, FIG. 4 shows the ring back setting table 123 of the originator terminal 102₁C, however, in this description, the ring back tone setting table in FIG. 4 is treated as that of the receiver terminal 102₂C. In FIG. 24, the same reference number is assigned to processes being the same as those in FIG. 14.

The receiver terminal 102₂C, when receiving distance information from the location information server 103C (Step S421:Y), judges whether the value “1” has been set for the flag setting column 141 in the ring back tone table 123 of the receiver terminal 102₂C (Step S262). When the value “1” representing that the execution of the ring back tone changing mode is allowed is set (Y), based on this information, the distance between the originator terminal 102₁C and receiver terminal 102₂C is calculated (Step S422). Then, the obtained distance information is compared with the distance range 142 stored in the ring back tone setting table 123 of the receiver terminal 102₂C. Then, a corresponding music composition and its tempo are read out to be determined (Step S264). Thereafter, the ring back tone is outputted using the determined music composition and its tempo at the Step 264 (Step S260).

Next, whether or not the receiver terminal 102₂C answers the phone and the connection is completed is checked (Step S451). When the connection is completed (Y), all processes are terminated and outputting of the ring back tone ends (END). Until the connection is terminated (Step S451:N), the routine returns back to the Step S261 to wait for the receipt of distance information. Then, the receiver terminal 102₂C, when receiving location information from the location information server 103C (Step S421:Y), judges whether the value “1” is set for the flag setting column 141 of the ring back tone setting table 123 of the receiver terminal 102₂C (Step S262). When the signal “1” representing that the execution of the ring back ring changing mode is allowed is set (Y), based on this information, the distance between the originator terminal 102₁C and receiver terminal 102₂C is calculated (Step S422) and the calculated distance is compared with the distance range stored in the ring back tone setting table 123. Then, a corresponding music composition and its tempo are read out (Step S264) and processing of outputting the ring back tone is repeated. As a result, when the distance between the originator terminal 102₁C and receiver terminal 102₂C is changed due to the repetition of the above processing until the completion of connection while a ring back tone is making a calling sound, the ring back tone changes depending on the distance change, thus enabling user's easy recognition of the distance change.

On the other hand, if the value “0” has been set for the flag setting column 141 of the ring back tone setting table 123 at the Step S262, it means that a user of the receiver terminal 102₂C does not desire the execution of the ring back tone changing mode. Therefore, in this case (N), until the connection is completed (Step S452:N), the old ring back tone is outputted (Step S453).

Moreover, when the receiver terminal 102₂C is out of service area where radio waves do not reach, no ring back tone is outputted, resulting in no need for the comparison (Step S226) of the distance information with the information stored in the ring back tone table 123.

In the fourth exemplary embodiment, the location information server 103C is handled as a device different from the switching system. However, when the location information server 103C and the switching system can be used commonly, it is natural that the processing shown in FIGS. 22 to 24 can be changed in each case. This is the same for the case where the location information server 103C and the home location register are commonly used.

According to the fourth exemplary embodiment explained above, a user of each of the originator terminal 102₁C and receiver terminal 102₂C can easily detect a distance between the terminals by hearing a ring back tone. Therefore, a user, when meeting someone for an appointment, can easily detect a change in distance between the originator terminal 102₁C and receiver terminal 102₂C by periodically sending out a ring back tone. Moreover, when compared with the first exemplary embodiment, the calculation of a distance by the location information server 103C is not required and, therefore, loads on the device can be reduced. No acquirement of location of the originator terminal 102₁C is required and, therefore, the processing for this is not needed accordingly.

Also, according to the fourth exemplary embodiment, a call is being made to the receiver terminal 102₂C, a distance between the originator terminal 102₁C and receiver terminal 102₂C can be continuously detected.

### Fifth Exemplary Embodiment

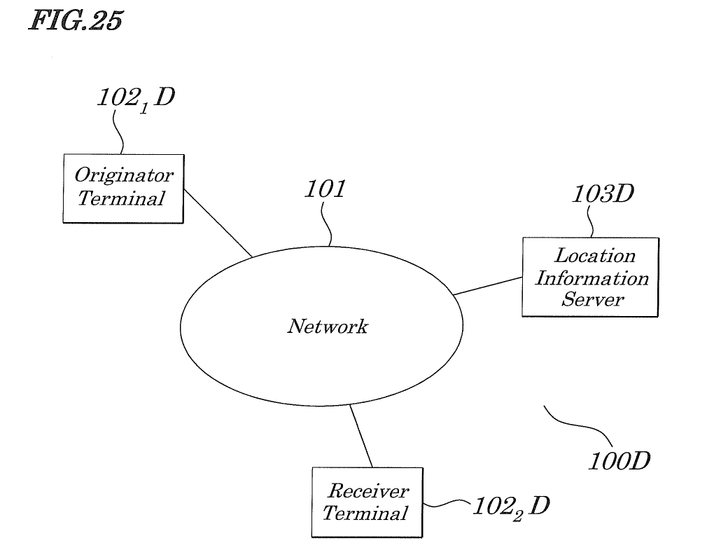

FIG. 25 is a diagram showing an overview of a communication system of the fifth exemplary embodiment of the present invention. The communication system 100D of the fifth exemplary embodiment includes a network 101 such as a mobile phone network, the Internet, or a like, an originator terminal 102₁D serving as the first communication terminal on an originator side connected to the network 10, a receiver terminal 102₂D serving as the second communication terminal on a signal receiver side, and a location information server 103D to manage location information.

Each of the originator terminal 102₁D and receiver terminal 102₂D is made up of communicating devices such as a mobile phone, PHS, PDA having a communicating function, portable-type personal computer also with a function of communicating, or a like.

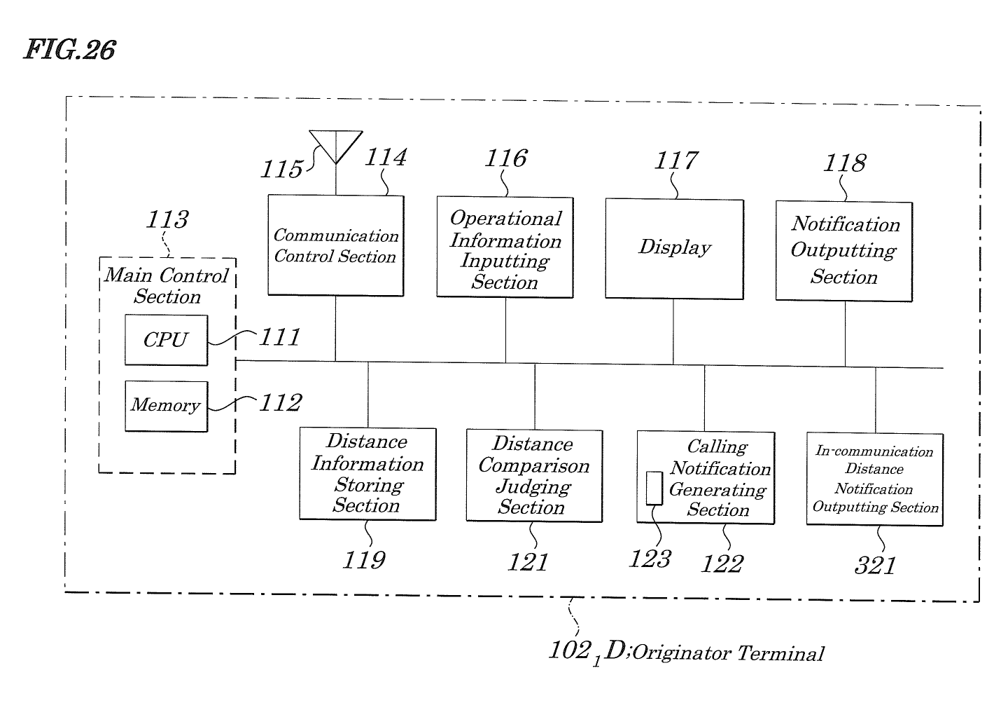

FIG. 26 is a block diagram showing basic configurations of an originator terminal of the fifth exemplary embodiment of the present invention. The receiver terminal 102₂D to be used in the fifth exemplary embodiment (FIG. 25) has the same configurations as the originator terminal 102₁D and their illustrations and descriptions are omitted accordingly. Moreover, the same reference number is assigned to each of circuits of the originator terminal 102₁D being basically the same as those of the originator terminal 102₁ employed in the first exemplary embodiment and their descriptions are omitted, if appropriate, accordingly.

In the communication system 100D of the fifth exemplary embodiment shown in FIG. 25, the location information server 103D detects a set of the originator terminal 102₁D and receiver terminal 102₂D both being in a mode called an in-communication distance notification mode and obtains the location information to calculate the distance. Therefore, it is not necessary that the originator terminal 102₁D has the location information obtaining section 124 employed in the originator terminal 102₁ of the first exemplary embodiment and the originator terminal 102₁D has, instead of a location information obtaining section 124, an in-communication distance notification outputting section 321 to notify the network 101 of the information that the originator terminal 102₁D and the receiver terminal 102₂D are in the in-communication distance notification mode.

The in-communication distance notification outputting section 321, when the operation mode of either or both of the originator terminal 102₁ D and the receiver terminal 102₂D is changed to the in-communication distance notification mode according to setting, or to each manipulation of a user of these terminals, is configured to output the in-communication distance notification to the network 101. The in-communication distance notification contains dial information of the terminals being scheduled to be communicated with each other or being in communication with each other. However, if location information of the originator terminal 102₁D is able to be obtained by a GPS, instead of dial information of the originator terminal 102₁D, its present location information can be contained.

In the fifth exemplary embodiment, the in-communication distance notification outputting section 321 is configured to output, at specified intervals, the in-communication distance notification in the time zone during which, for example, the user of the terminal sets its operation mode at the in-communication distance notification mode. Therefore, for example, if one runner participated in a marathon tournament brings the originator terminal 102₁D and another runner brings the receiver terminal 102₂D, by carrying out the communication between both terminals in the in-communication distance notification mode, a change in distance can be detected continuously.

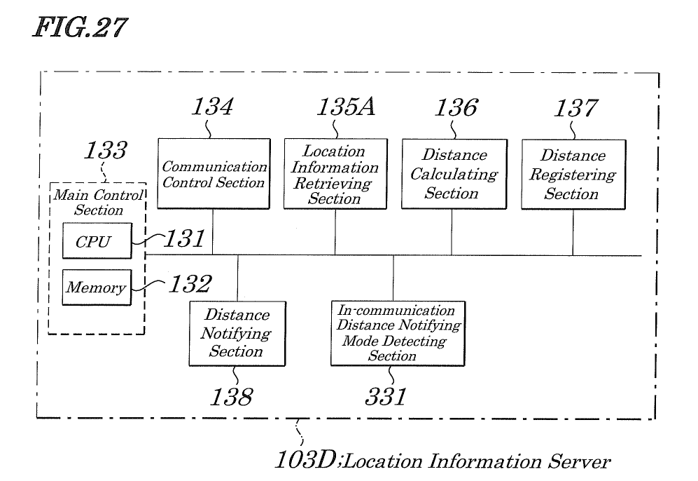

FIG. 27 is a block diagram showing an overview of a location information server of the fifth exemplary embodiment of the present invention. In FIG. 27, the same reference numbers are assigned to each of circuits of the location information server 103D being basically the same as the location information server 103 in FIG. 3 and their descriptions are omitted, if appropriate, accordingly. The location information server 103D newly has the in-communication distance notifying mode detecting section 331 configured to detect a communication terminal operating in the in-communication distance notification mode.

The method of detecting in-communication distance notification employed by the in-communication distance notifying mode detecting section 331 includes various methods in which, for example, specified data is detected on the network 101. There are, for example, methods in which in-communication distance notification is made to be written by using, as an address, the location information server 103D itself or a specified common buffer area on the network, or in-communication distance notification is made to be transmitted from a switching system (not shown) under consent among terminals.

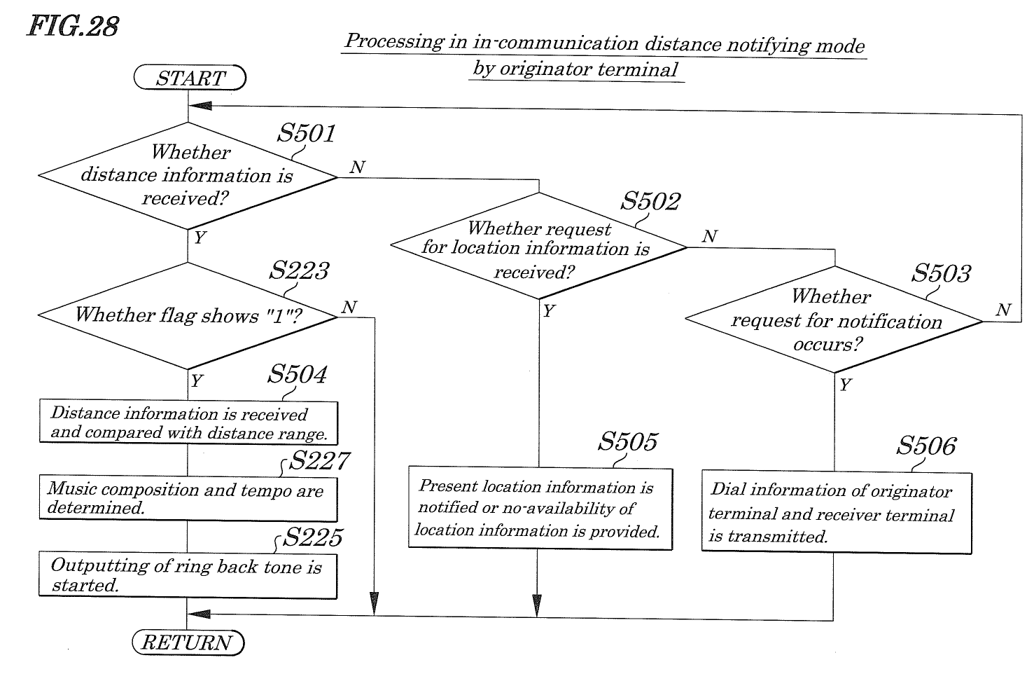

FIG. 28 is a flow chart explaining contents of processing of the in-communication distance notification mode to be performed by the originator terminal of the fifth exemplary embodiment of the present invention. In the fifth exemplary embodiment, the originator terminal 102₁D and the receiver terminal 102₂D shown in FIG. 26 perform the same operations and their descriptions are omitted accordingly. In FIG. 28, the same reference numbers are assigned to the same portions as shown in FIG. 6.

The originator terminal 102₁D is monitoring, in a state in which the in-communication distance notification mode is now being performed, whether distance information is transmitted from the location information server 103D shown in FIG. 25 (Step S501), whether there is a request for location information of the originator terminal 102₁D from the same location information server 103D (Step S502), or whether a request for the in-communication distance notification occurs within the originator terminal 102₁D (Step S503).

The originator terminal 102₁D, when distance information is transmitted from the location information server 103D (Step S501:Y), judges whether the value “1” is set for the flag setting column 141 in the ring back tone setting table 123 shown in FIG. 4 (Step S223). When the signal “1” representing that the ring back tone changing mode is allowed is set (Y), the originator terminal 102₁D receives distance information and compares the received distance information with contents of the ring back tone setting table 123 shown in FIG. 4 (Step S504). Then, a corresponding music composition and its tempo are read out to determine a ring back tone (Step S227). Thereafter, outputting of the ring back tone is started (Step S225). It is needless to say that this ring back tone is not a sound for calling a communication party but a sound showing a distance range.

On the contrary, when the signal “0” representing that the ring back tone changing mode is not allowed is set (Step S223:N), the processing is terminated without performing any other particular process (END). Also, if the originator terminal 102₁D is outputting a normal ring back tone, the routine is continued as it is. Moreover, by making only the receiver terminal 102₂D reference to the flag, the originator terminal 102₁D may immediately let the routine proceed to the processing at the Step S504 onward without checking the flag.

When a request for location information is made from the location information server 103D at the Step S504 (Y), the originator terminal 102₁D, when having its own present exact location information, transmits the location information to the location information server 103D (Step S505). This is the case, for example, in which the newest information obtained by using the GPS is available. If such location information is not available, the originator terminal 102₁D notifies the location information server 103 of non-availability of the information. In this case, the location information server 103D for itself looks for the location information as described later.

Next, the case is described in which a request for in-communication distance notification occurs within the originator terminal 102₁D (Step S503:Y), which includes one time occurrence and continuous occurrence of the request. In any case of the occurrence of the request, the originator terminal 102₁D continuously transmits, while a request for the in-communication distance notification occurs, dial information of the originator terminal 102₁D and receiver terminal 102₂D being a terminal of a communicating party to the location information server 103D (Step S506). Instead of dial information of the originator terminal 102₁D itself, the newest location information obtained by the GPS may be transmitted.

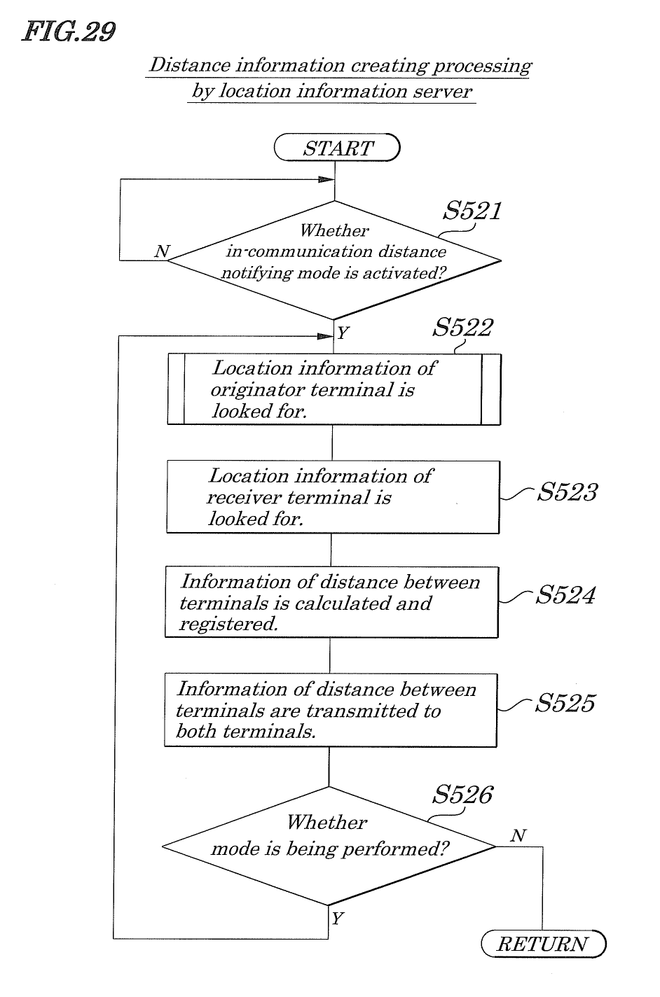

FIG. 29 is a flow chart showing processing of creating distance information to be performed by the location information server 103D of the fifth exemplary embodiment of the present invention. The location information server 103D first looks for, when the in-communication distance notifying mode detecting section 331 shown in FIG. 27 detects the activation of the in-communication distance notification mode (or occurrence of request for the in-communication distance notification) at any one of terminals (Step S521:Y), location information of the originator terminal 102₁D being paired with the receiver terminal 102₂D (Step S522).

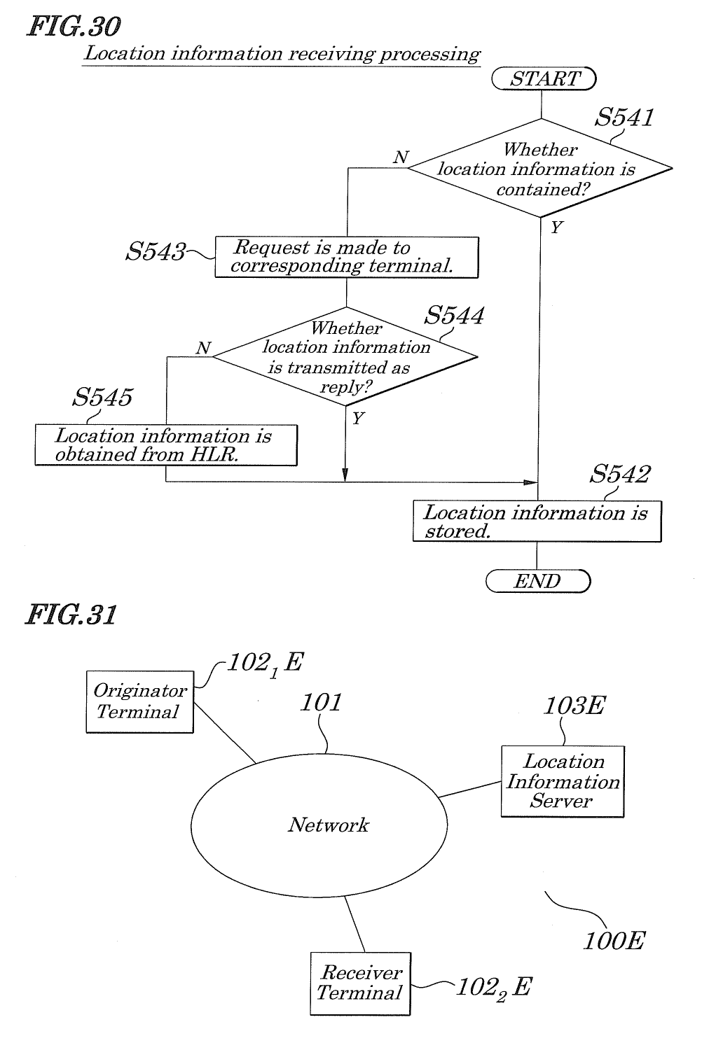

FIG. 30 is a flow chart specifically showing processing of looking for location information of the originator terminal 102₁D to be performed by the location information server 103D. The processing of looking for location information of the receiver terminal 102₂D is basically the same as the processing shown in FIG. 30 and their descriptions are omitted accordingly. First, the location information server 103D, when the location information of the originator terminal 102₁D is contained in the information transmitted from the originator terminal 102₁D (Step S541:Y), stores the location information in a specified area without performing its particular retrieving processing (Step S542) and terminates the processing (END). An example of the above case is that the originator terminal 102₁D, in response to a request for in-communication distance notification, transmits its own newest location information obtained by the measurement using the GPS.

If such location information is not contained (Step S541:N), a request for location information is made to the originator terminal 102₁D as a corresponding terminal (Step S543). When, in response to the request, the originator terminal 102₁D transmits the prepared newest location information (Step S544:Y), stores the information as the location information (Step S542) and terminates the processing (END).

If the originator terminal 102₁D does not make a response due to no preparation of appropriate location information (Step S544:N), as described at the Step S242, the location information retrieving section 135A (FIG. 27) obtains, by using dial information of the originator terminal 102₁D, the location information from the home location register (Step S545).

The description is made again by referring to FIG. 29. The location information server 103D, after looking for the location information of the originator terminal 102₁D to obtain the information, further looks for location information of the receiver terminal 102₂D paired with the originator terminal 102₁D to obtain the information (Step S523). Then, the location information server 103D calculates a distance between the originator terminal 102₁D and receiver terminal 102₂D by using the obtained distance information and stores the calculated distance in the distance registering section 137 shown in FIG. 27 (Step S524). Then, the distance information server 103D transmits the distance information to the originator terminal 102₁D and receiver terminal 102₂D (Step S525). When it is judged that the in-communication distance notifying mode detecting section 331 is still continuously in the in-communication distance notification mode (Step S526: N), during the period of time, the routine is returned to the Step S522 and processing at the Step S522 to Step S525 is repeated. Each of the users of the originator terminal 102₁D and receiver terminal 102₂D can detect a change in each other's distance near a meeting place.

Thus, according to the fifth exemplary embodiment of the present invention, each of the users of the originator terminal 102₁D and receiver terminal 102₂D can easily judge a distance between both terminals or a change in the distance for a long time or every time a request is made by using the in-communication distance notification mode. Additionally, the location information server 103D can obtain the location information to be based on the calculation of the distance by using a plurality of methods. Therefore, it is made possible to increase not only probability of the measurement of a distance but also probability of obtaining highly accurate results.

Moreover, in the fifth exemplary embodiment, it is possible to obtain results of the calculation of not only a period during which a ring back tone is being produced by dialing but also a distance in any section required by a user during the communication.

### Sixth Exemplary Embodiment

FIG. 31 is a diagram showing an overview of a communication system of the sixth exemplary embodiment of the present invention. The communication system 100E of the sixth exemplary embodiment includes a network 101 such as a mobile phone network, the Internet, or a like, an originator terminal 102₁E serving as the first communication terminal on an originator side connected to the network 10, a receiver terminal 102₂E serving as the second communication terminal on a signal receiver side, and a location information server 103E to manage location information.

Each of the originator terminal 102₁E and receiver terminal 102₂E is made up of communicating devices such as a mobile phone, PHS, PDA having a communicating function, portable-type personal computer also with a function of communicating, or a like.

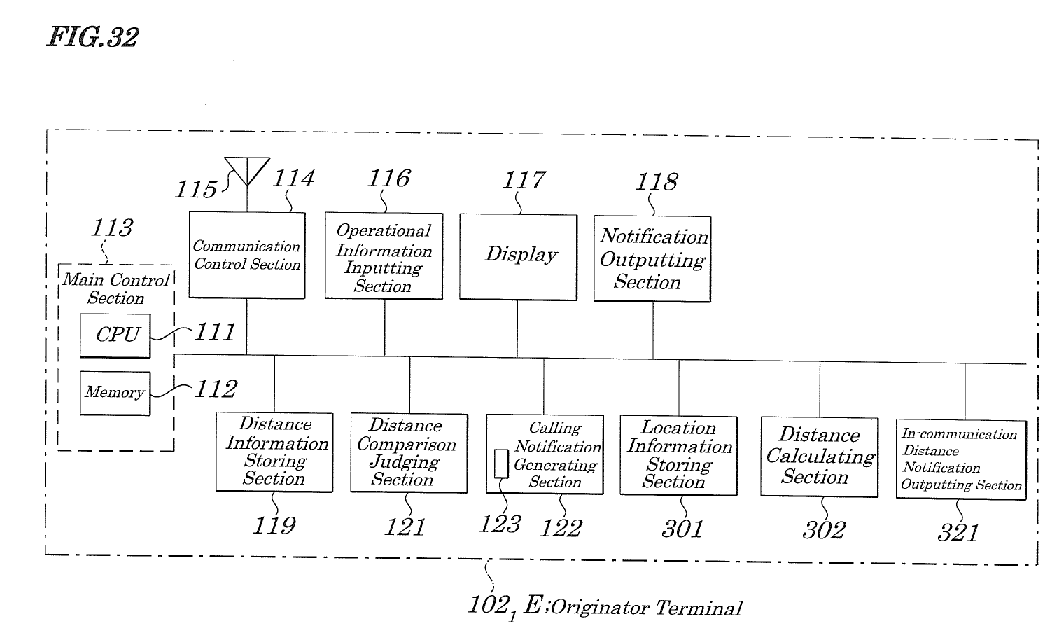

FIG. 32 is a block diagram showing basic configurations of the originator terminal of the sixth exemplary embodiment of the present invention. The receiver terminal 102₂E employed in the sixth exemplary embodiment (FIG. 31) has the same configurations as the originator terminal 102₁E and their illustrations and descriptions are omitted accordingly. Moreover, in FIG. 32, the same reference numbers are assigned to each of circuits of the originator terminal 102₁E being basically the same as those of the originator terminal 102₁ employed in the first exemplary embodiment or the originator terminal 102₁A in the second exemplary embodiment and their descriptions are omitted, if appropriate, accordingly.

In the communication system 101E of the sixth exemplary embodiment shown in FIG. 31, the location information server 103E detects a set of the originator terminal 102₁E and receiver terminal 102₂E both being in a mode called an in-communication distance notification mode and obtains the location information and to notify both the terminals of the location information. Therefore, it is not necessary that the originator terminal 102₁E has the location information obtaining section 124 employed in the originator terminal 102₁ of the first exemplary embodiment and the originator terminal 102₁E has, instead of the location information obtaining section 124, an in-communication distance notification outputting section 321 to notify the network 101 of the information that the originator terminal 102₁E and receiver terminal 102₂E are in the in-communication distance notification mode, the location information storing section 301 and distance calculating section 302.

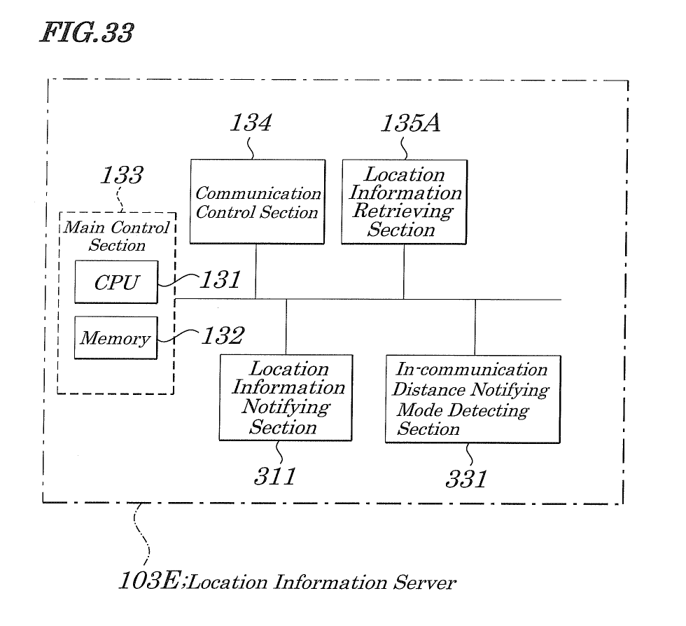

FIG. 33 is a block diagram showing configurations of a location information server 103E of the sixth exemplary embodiment of the present invention. As in the case of the location information server 103A of the second exemplary embodiment, it is not necessary that the location information server 103E has the distance calculating section 136 and distance registering section 137 shown in FIG. 3. Also, in the location information server 103E, since the location information is notified to both the originator terminal 102₁E and receiver terminal 102₂E, the distance notifying section 138 (shown in FIG. 3) is not provided and, instead of that, the location information notifying section 311 to notify location information to both terminals. As in the case of the location information server 103D of the fifth exemplary embodiment, the in-communication distance notifying mode detecting section 331 to detect a communication terminal being in the in-communication distance notification mode within the network 101 is provided.

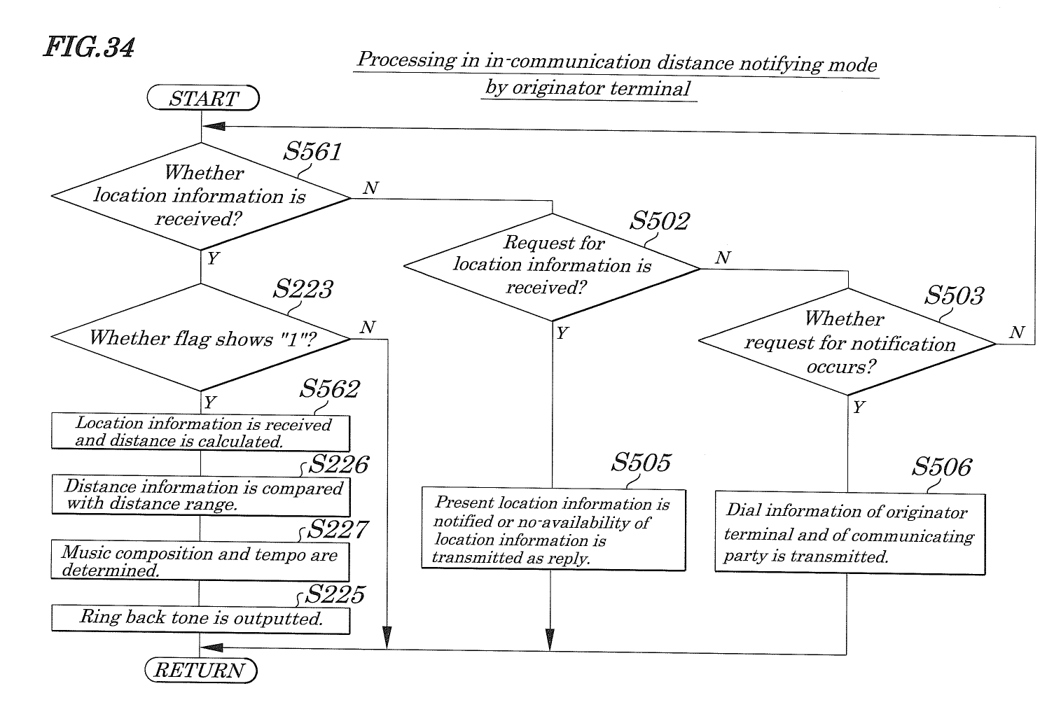

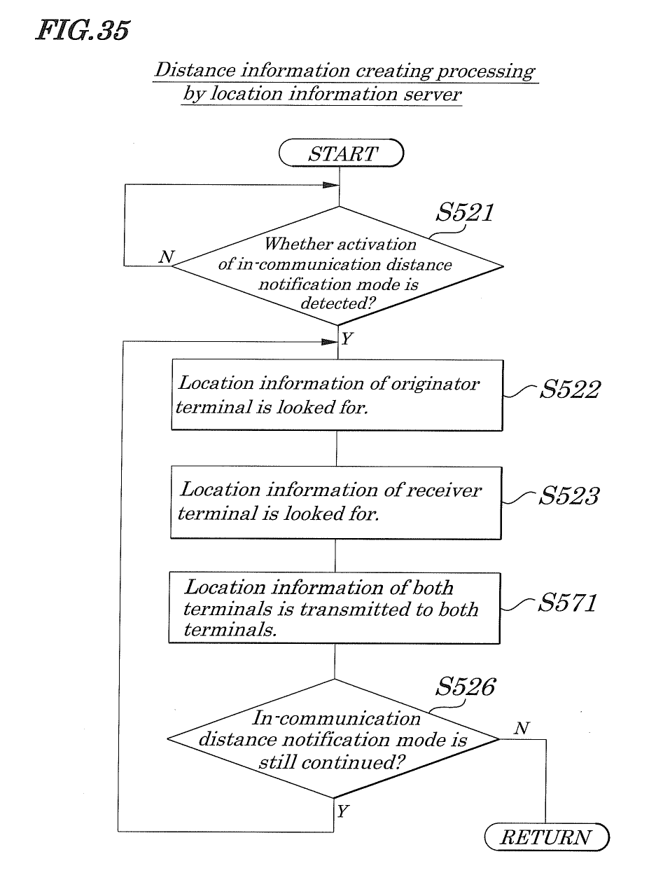

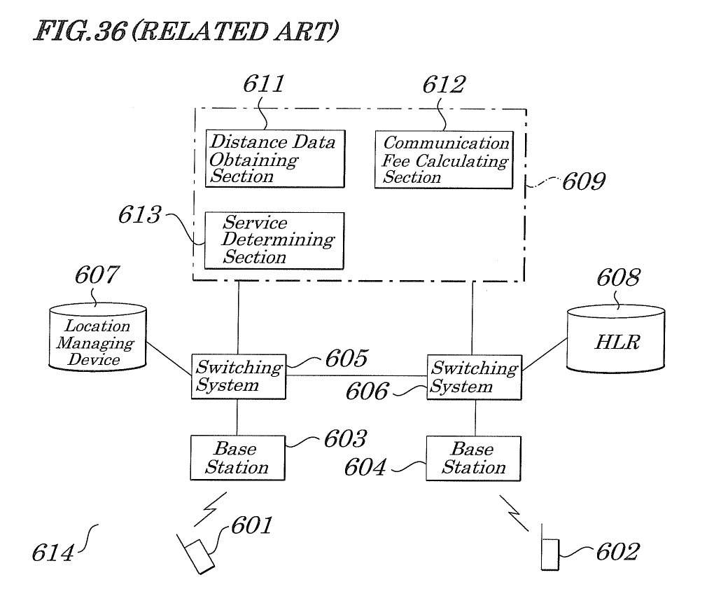

FIG. 34 is a flow chart explaining contents of processing of an in-communication distance notification mode to be performed by the originator terminal 102₁E of the sixth exemplary embodiment of the present invention. In this exemplary embodiment, the originator terminal 102₁E shown in FIG. 31 performs the same operations as the receiver terminal 102₂E and their descriptions are omitted. In FIG. 34, the same reference number is assigned to processes being the same as those in FIG. 28.

The originator terminal 102₁E is monitoring, in a state in which the in-communication distance notification mode is now being performed, whether location information is transmitted from the location information server 103E shown in FIG. 31 (Step S561), whether there is a request for location information of the originator terminal 102₁E from the same location information server 103E (Step S502), or whether a request for the in-communication distance notification occurs within the originator terminal 102₁E (Step S503).

First, when location information is transmitted from the location information server 103E (Step S561:Y), the originator terminal 102₁E judges whether the value “1” is set for the flag setting column 141 in the ring back tone setting table 123 shown in FIG. 4 (Step S223). If the signal “1” is set which represents that the execution of the ring back tone changing mode is allowed (Y), the originator terminal 102₁E receives location information to calculate a distance (Step S562) and compares the obtained distance information with contents of the ring back tone setting table 123 shown in FIG. 4 (Step S226). Then, a music composition and its tempo in a corresponding distance range are read out to determine a ring back tone (Step S227). Thereafter, outputting of the ring back tone is started (Step S225).

On the contrary, when the signal “0” is set which represents that the execution of the ring back tone changing mode is not allowed (Step S223:N), any further particular processing is not performed and the routine ends (END). If the originator terminal 102₁E is outputting, for example, a normal ring back tone, the routine is continued as it is. Moreover, by making only the receiver terminal 102₂E reference to the flag, the originator terminal 102₁E may immediately let the routine proceed from the processing at the Step S561 to the processing at the Step S562 onward without checking of the flag.

At the Step S502, when a request for location information is made by the location information server 103E (Y), if the originator terminal 102₁E has its own present exact location information, the originator terminal 102₁E transmits the information as a reply. An example of the above case is that the location information obtained by the GPS is available. If such location information is not available, the originator terminal 102₁E notifies the location information server 103E of the non-availability. In this case, the location information server 103 itself looks for the location information as explained later.

Next, the case is described in which a request for in-communication distance notification occurs within the originator terminal 102₁D (Step S503:Y), which includes one time occurrence and continuous occurrence of the request. In any case of the occurrence of the request, the originator terminal 102₁E continuously transmits, while a request for the in-communication distance notification occurs, dial information of the originator terminal 102₁E and receiver terminal 102₂E being a terminal of a communicating party to the location information server 103E (Step S506). Instead of dial information of the originator terminal 102₁E itself, the newest location information obtained by the GPS may be transmitted.

FIG. 35 is a flow chart showing processing of creating distance information to be performed by a location information server of the sixth exemplary embodiment of the present invention. The location information server 103E, when the in-communication distance notifying mode detecting section 331 shown in FIG. 33 detects the activation(or request for the in-communication distance notification) of the in-communication distance notification mode in any one of terminals (Step S521:Y), looks for location information of the originator terminal 102₁E being paired with the receiver terminal 102₂E (Step S522). This processing is the same as that in the fifth exemplary embodiment in FIG. 30.

After the location information of the originator terminal 102₁E is looked for and obtained at the Step S522, location information of the receiver terminal 102₂E being paired with the originator terminal 102₁E is looked for and obtained (Step S523). Then, the information is transmitted to both the originator terminal 102₁E and receiver terminal 102₂E. Thereafter, the in-communication distance notifying mode detecting section 331 judges that the in-communication distance notification mode is still continued (Step S526:Y), during the time, the routine is returned to the Step 522 and processing at the Step S522 to Step S571 is repeated. Each of the originator terminal 102₁E and receiver terminal 102₂E can easily detect a change in distance between the originator terminal 102₁A and receiver terminal 102₂A in a location being near to a meeting place.

Thus, according to the sixth exemplary embodiment of the present invention, each of the users of the originator terminal 102₁E and receiver terminal 102₂E can easily judge a distance between both terminals or a change in the distance for a desired time or every time a request is made by using the in-communication distance notification mode. Additionally, the location information server 103E can obtain the location information to be based on the calculation of the distance by using a plurality of methods. Therefore, it is made possible to increase not only probability of the measurement of a distance but also probability of obtaining highly accurate results.

Moreover, in the sixth exemplary embodiment, it is possible to obtain results of the calculation of not only a period during which a ring back tone is being produced by dialing but also a distance in any section required by a user during the communication.

It is apparent that the present invention is not limited to the above exemplary embodiments but may be changed and modified without departing from the scope and spirit of the invention. For example, in the above exemplary embodiments, the case is explained in which, by using, for example, the notification outputting section 118 shown in FIG. 2 and sound information such as a music composition, a distance between both terminals is notified, however, the present invention is not limited to the notification of a distance by a sound. That is, by configuring the display 117 shown in FIG. 2 so that a character, symbol or color is displayed in a concrete or abstract manner, a user may get the distance information. Furthermore, a method of getting the distance information by using a quantity of light or intensity of light emitted from a light emitting diode or a like.

Also, in the method by which a user can get distance information using these five senses of a human, the present invention is not limited to the case in which one type of the use of the five senses is singly employed (for example, only visual sense is used), that is, visual and auditory displaying methods may be combined appropriately to let a user know a distance.

Moreover, in the above exemplary embodiments, the distance is used in several stages, however, the distance range may be displayed on the display 117 by a number or value in a concrete manner. Also, a background color in the display 117, color of display lamp representing call origination or call receiving, or flashing time of the lamp may be continuously changed depending on each distance.

Furthermore, in the above exemplary embodiments, the distance of a set of communication terminals such as the set of the originator terminal 102₁E and receiver terminal 102₂E, however, the present invention is not limited to this. For example, in the case of a conference by phone, a distance relation among communication terminals of users joining the conference may be displayed.

What is claimed is:

1. A communication terminal comprising:
a communication terminal specified information transmitting unit to transmit communication terminal specified information for identifying each of communication terminals making up one set of terminals communicating with each other through a network;
a distance information receiving unit to receive distance information when said distance information representing a distance, calculated based on the communication terminal specified information transmitted by said communication terminal specified information transmitting unit, between the one communication terminal and the other communication terminal making up said one set of terminals is transmitted from said network; and
a distance information displaying unit to display the distance information received by said distance information receiving unit.

2. The communication terminal according to claim 1, further comprising a distance threshold setting unit to set a plurality of threshold values, wherein said distance information displaying unit compares said distance information with a threshold value set by the distance threshold setting unit and displays said distance information in stages.

3. The communication terminal according to claim 1, wherein said distance calculating unit switches a music composition to be outputted as a sound for connection between the one communication terminal and the other communication terminal depending on the distance.

4. The communication terminal according to claim 1, wherein said distance calculating unit switches a tempo of a music composition of a ring back tone to be outputted as a sound for connection between the one communication terminal and the other communication terminal depending on the distance.

5. A communication terminal comprising:
a communication terminal specified information transmitting unit to transmit communication terminal specified information for identifying each of communication terminals making up one set of terminals communicating with each other through a network;
a location information receiving unit to receive location information when said location information representing a location, obtained based on the communication terminal specified information transmitted by said communication terminal specified information transmitting unit, between the one communication terminal and the other communication terminal making up said one set is transmitted from said network;
a distance information calculating unit to calculate a distance between the one communication terminal and the other communication terminal making up said one set based on the information received by said location information receiving unit; and
a distance information displaying unit to display information about the distance calculated by said distance information calculating unit.

6. The communication terminal according to claim 5, further comprising a distance threshold setting unit to set a plurality of threshold values, wherein said distance information displaying unit compares said distance information with a threshold value set by the distance threshold setting unit and displays said distance information in stages.

7. The communication terminal according to claim 5, wherein said distance calculating unit switches a music composition to be outputted as a sound for connection between the one communication terminal and the other communication terminal depending on the distance.

8. The communication terminal according to claim 5, wherein said distance calculating unit switches a tempo of a music composition of a ring back tone to be outputted as a sound for connection between the one communication terminal and the other communication terminal depending on the distance.

9. A communication system comprising:
a network for communication;
a location information server having a distance calculating unit connected to said network to receive network terminal specified information identifying each of communication terminals making up one set of terminals each carrying out communication with each other through said network to calculate a distance between the communication terminals and a distance calculating result transmitting unit to transmit calculating results obtained by said distance calculating unit as distance information to each of the communication terminals making up said one set of terminals; and
communication terminals, each of which comprises:
a communication terminal specified information transmitting unit to transmit communication terminal specified information for identifying each of communication terminals making up one set of terminals communicating with each other through a network;
a distance information receiving unit to receive distance information when said distance information representing a distance, calculated based on the communication terminal specified information transmitted by said communication terminal specified information transmitting unit, between the one communication terminal and the other communication terminal making up said one set of terminals is transmitted from said network; and
a distance information displaying unit to display the distance information received by said distance information receiving unit.

10. A communication system comprising:
a network for communication;
a location information server having a location retrieving unit connected to said network to receive network terminal specified information identifying each of communication terminals making up one set of terminals each carrying out communication with each other through said network and to retrieve a location between the communication terminals and a location retrieving result transmitting unit to transmit retrieved results obtained by said location retrieving unit as location information to each of the communication terminals making up said one set of terminals; and
communication terminals, each of which comprises:
a communication terminal specified information transmitting unit to transmit communication terminal specified information for identifying each of communication terminals making up one set of terminals communicating with each other through a network;
a location information receiving unit to receive location information when said location information representing a location, obtained based on the communication terminal specified information transmitted by said communication terminal specified information transmitting unit, between the one communication terminal and the other communication terminal making up said one set is transmitted from said network;
a distance information calculating unit to calculate a distance between the one communication terminal and the other communication terminal making up said one set based on the information received by said location information receiving unit; and
a distance information displaying unit to display information about the distance calculated by said distance information calculating unit.

11. An information displaying program product of communication terminals for making a computer for a communication terminal execute;
a communication terminal specified information transmitting processing of transmitting communication terminal specified information for identifying each of communication terminals making up one set of terminals communicating with each other through a network;
a distance information receiving processing of receiving distance information when said distance information representing a distance, calculated based on the communication terminal specified information transmitted by said communication terminal specified information transmitting processing, between the one communication terminal and the other communication terminal making up said one set is transmitted from said network; and
a distance information displaying processing of displaying the distance information received by said distance information receiving processing.

12. An information displaying program product of communication terminals for making a computer for a communication terminal execute;
a communication terminal specified information transmitting processing of transmitting communication terminal specified information for identifying each of communication terminals making up one set of terminals communicating with each other through a network;
a location information receiving processing of receiving distance information when said location information representing a location, calculated based on the communication terminal specified information transmitted by said communication terminal specified information transmitting processing, between the one communication terminal and the other communication terminal making up said one set is transmitted from said network;
a distance information calculating processing of calculating a distance between the one communication terminal and the other communication terminal making up said one set based on the location information received by said location information receiving processing; and
a distance information displaying processing of displaying information about the distance calculated by the distance information calculating processing.

13. An information displaying method comprising:
a communication terminal specified information transmitting step of transmitting communication terminal specified information for identifying each of communication terminals making up one set of terminals communicating with each other through a network;
a distance information receiving step of receiving distance information when said distance information representing a distance, calculated based on the communication terminal specified information transmitted by said communication terminal specified information transmitting step, between the one communication terminal and the other communication terminal making up said one set is transmitted from said network; and
a distance information displaying step of displaying the distance information received by said distance information receiving step.

14. An information displaying method comprising:
a communication terminal specified information transmitting step of transmitting communication terminal specified information for identifying each of communication terminals making up one set of terminals communicating with each other through a network;
a location information receiving step of receiving location information when said location information representing a location, calculated based on the communication terminal specified information transmitted by said communication terminal specified information transmitting step, between the one communication terminal and the other communication terminal making up said one set is transmitted from said network;
a distance information calculating step of calculating a distance between the one communication terminal and the other communication terminal making up said one set based on the information received by said location information receiving step; and
a distance information displaying step of displaying information about the distance calculated by the distance information calculating step.

15. A communication terminal comprising:
a communication terminal specified information transmitting means to transmit communication terminal specified information for identifying each of communication terminals making up one set of terminals communicating with each other through a network;
a distance information receiving means to receive distance information when said distance information representing a distance, calculated based on the communication terminal specified information transmitted by said communication terminal specified information transmitting means, between the one communication terminal and the other communication terminal making up said one set of terminals is transmitted from said network; and
a distance information displaying means to display the distance information received by said distance information receiving means.

16. A communication terminal comprising:
a communication terminal specified information transmitting means to transmit communication terminal specified information for identifying each of communication terminals making up one set of terminals communicating with each other through a network;
a location information receiving means to receive location information when said location information representing a location, obtained based on the communication terminal specified information transmitted by said communication terminal specified information transmitting means, between the one communication terminal and the other communication terminal making up said one set is transmitted from said network;
a distance information calculating means to calculate a distance between the one communication terminal and the other communication terminal making up said one set based on the information received by said location information receiving means; and
a distance information displaying means to display information about the distance calculated by said distance information calculating means.
